(19) United States
(12) Patent Application Publication
(10) Pub. No.: US 2006/0237532 A1
(43) Pub. Date: Oct. 26, 2006

(54) System and method for facilitating in-store customer service, product marketing and inventory management

(75) Inventors: Sherry L. Scott-Leikach, Redwood City, CA (US); Benjamin Leikach, Redwood City, CA (US)

Correspondence Address: SQUIRE, SANDERS & DEMPSEY L.L.P, 600 HANSEN WAY, PALO ALTO, CA, 94304-1043, US

(73) Assignee: STYLE AND FORM, INC.., Incorporation: Delaware

(21) Appl. No.: 11/111,073

(22) Filed: Apr. 20, 2005

(51) Int. Cl. G06K 15/00; G06K 7/10

(52) U.S. Cl. 235/383; 235/462.46; 235/472.02

(57) ABSTRACT

In one embodiment, a method, includes receiving a customer in a retail establishment; providing a mobile device to the customer; enabling the customer to use the mobile device to selectively enter product identifiers of products in the retail establishment; and enabling the customer to request an associated service in the retail establishment, the associated service using the product identifier. The associated service may be an email service, a point-of-sale service, a design assistant service, a product information service, or a storage service. The product identifier may be a bar code or other wireless protocol.

### PRIORITY CLAIM TO PRIOR APPLICATIONS

This application claims priority to application Ser. No. 10/991,174, entitled “System and Method for Automatically Assisting a Consumer with Space Design and Furnishings Selection,” filed on Nov. 16, 2004 by the same inventors, and is incorporated by reference as if copied verbatim hereafter.

### BACKGROUND

1. Technical Field

This invention relates generally to sales, and more particularly provides a system and method for facilitating in-store customer service, product marketing and inventory management of products and/or services.

2. Description of the Background Art

In-store marketing is used by retail establishments to market goods and/or services to consumers. Typically, a retail establishment maintains printed materials such as product brochures, which are distributed to consumers either upon request or via displays typically located near corresponding floor samples.

Conventional in-store marketing materials often require many steps to create and distribute, and often do not enable effective monitoring of marketing results. In one example, a manufacturer may create brochures for a product line, and may deliver the brochures to various retailers. The retail establishments hire sales staff to hand out the printed material upon customer request and/or to arrange brochure displays. This typical process is inefficient and ineffective in many ways. This process requires sales staff either to be ready to assist the many customers or to make certain that the displays are fully stocked. Further, in many instances, customers are unaware that printed materials are available and do not request them. Also, retailers may run out of printed brochures. Still further, conventional in-store marketing does not enable a convenient way of measuring the effectiveness of the marketing materials.

Due to the expense of hiring sales employees, retail establishments may be understaffed. Customers seeking product brochures and/or other assistance may find themselves waiting until a staff member has finished assisting another customer. In such cases, those customers not wishing to wait may leave the establishment in frustration.

Therefore, systems and methods that provide more efficient in-store marketing, improve the shopping experience of each customer, and increase the likelihood of product satisfaction would be helpful. As expected, such systems and methods could lead to greater sales and fewer returns.

### SUMMARY

The present invention enables multiple embodiments of systems and methods. Examples of such embodiments follow:

Email:

The present invention may provide an email system according to a first embodiment. The system includes products for sale in a retail establishment, each product having a product identifier; and a mobile device controlled by a customer of the retail establishment, the mobile device for receiving one of the product identifiers and for initiating the sending of an email containing product information corresponding to the received product identifier. The product identifier may be a bar code and the mobile device may include a bar code scanner for receiving the product identifier. The mobile device may be a PDA provided to the customer by the retail establishment. The system may include a server having an email service engine for sending the email, and the mobile device may communicate the product identifier to the server. The mobile device may include an email service engine for sending the email.

The present invention may also provide an email method, in accordance with another embodiment. The method includes receiving a product identifier of a product for sale in a retail establishment by a mobile device, the mobile device being controlled by a customer of the retail establishment; and initiating the sending of an email containing product information corresponding to the received product identifier. The step of receiving may include scanning a bar code. The mobile device may be a PDA provided to the customer by the retail establishment. The method may include using an email server to send the email, wherein the step of initiating includes communicating the product identifier to the email server. The method may include using the mobile device to send the email.

Product Specification Info:

The present invention may also provide a product information distribution system, in accordance with another embodiment. The system includes products for sale in a retail establishment, each product having a product identifier; and a mobile device controlled by a customer of the retail establishment, the mobile device for receiving one of the product identifiers and for presenting product information corresponding to the received product identifier. The product identifier may be a bar code and the mobile device includes a bar code scanner for receiving the product identifier. The mobile device may be a PDA provided to the customer from the retail establishment. The system may include a server capable of accessing a product information database storing the product information corresponding to the received product identifier and including a mobile device communication engine for communicating the product information to the mobile device. The mobile device may include a database storing the product information corresponding to the received product identifier.

The present invention may also provide a product information distribution method in accordance with another embodiment. The method includes receiving a product identifier of a product for sale in a retail establishment by a mobile device, the mobile device being controlled by a customer of the retail establishment; obtaining product information corresponding to the received product identifier; and presenting the product information on the mobile device. The step of receiving may include scanning a bar code. The mobile device may be a PDA provided to the customer from the retail establishment. The step of obtaining may include receiving the product information from a server. The step of receiving may include accessing a product information database on the mobile device.

Coordinating Products:

In accordance with another embodiment, the present invention may provide a product coordination system. The system includes products for sale in a retail establishment, each product having a product identifier; a mobile device being controlled by a customer of the retail establishment, the mobile device for receiving a product identifier; and a design assistant for suggesting other products that coordinate with the product corresponding to the received product identifier. The product identifier may be a bar code and the mobile device may include a bar code scanner for receiving the product identifier. The mobile device may be a PDA provided to the customer by the retail establishment. The design assistant may be located on a server. The design assistant may located on the mobile device.

In accordance with another embodiment, the present invention may provide a product coordination method. The method includes receiving a product identifier of a product for sale in a retail establishment by a mobile device, the mobile device being controlled by a customer of the retail establishment; and suggesting other products that coordinate with the product corresponding to the product identifier. The step of receiving may include scanning a bar code. The mobile device may be a PDA provided to the customer by the retail establishment.

Inventory Management:

In accordance with yet another embodiment, the present invention may provide an inventory management system. The system includes products for sale in a retail establishment, each product having a product identifier; a mobile device being controlled by a customer of the retail establishment, the mobile device for enabling the customer to selectively enter one of the product identifiers; and a database for storing product information of products corresponding to entered product identifiers. The product identifier may be a bar code and the mobile device may include a bar code scanner for receiving the product identifier. The mobile device may be a PDA provided to the customer by the retail establishment. The database may be located on a server or on the mobile device.

In accordance with another embodiment, the present invention may also provide an inventory management method. The method includes enabling a customer to selectively enter a product identifier of a product for sale in a retail establishment into a mobile device, the mobile device being controlled by the customer; and storing product information of the product corresponding to the entered product identifier. The product identifier may be a bar code. The mobile device may be a PDA provided to the customer by the retail establishment. The step of storing may include storing the product information in a database located on a server. The step of storing may include storing the product information in a database located on the mobile device.

Future Marketing:

In accordance with another embodiment of the present invention, the present invention may provide a marketing system. The system includes products for sale in a retail establishment, each product having a product identifier; a mobile device controlled by a customer of the retail establishment, the mobile device for enabling the customer to selectively enter one of the product identifiers; and a database for storing customer information and customer activity information. The product identifier may be a bar code and the mobile device may include a bar code scanner for capturing the product identifier. The mobile device may be a PDA provided to the customer by the retail establishment. The database may be located on a server or on the mobile device.

In accordance with another embodiment, the present invention may provide a marketing method. The method includes enabling a customer to selectively enter a product identifier of a product for sale in a retail establishment in a mobile device, the mobile device being controlled by the customer of the retail establishment; and storing customer information and customer activity information. The product identifier may be a bar code. The mobile device may be a PDA provided to the customer by the retail establishment. The step of storing may include storing the customer information and customer activity information in a database located on a server. The step of storing may include storing the customer information and customer activity information in a database located on the mobile device.

Business Method:

In accordance with yet another embodiment, the present invention may provide a business method. The business method includes receiving a customer in a retail establishment; providing a mobile device to the customer; enabling the customer to use the mobile device to selectively enter product identifiers of products in the retail establishment; and enabling the customer to request an associated service in the retail establishment, the associated service using the product identifier. The associated service may be an email service, a point-of-sale service, a design assistant service, a product information service, or a storage service.

Purchase Assist:

In accordance with another embodiment, the present invention may provide a purchasing assistance method. The method includes receiving a product identifier of a product for sale in a retail establishment by a mobile device, the mobile device being controlled by a customer of the retail establishment; receiving a request to purchase the product corresponding to the product identifier from the customer; and informing a sales associate of the request. The method may include the step of initiating the purchase of the product. The method may include the step of initiating retrieval of the product so that the product is waiting at a more convenient location in the retail establishment.

### BRIEF DESCRIPTION OF THE DRAWINGS

FIG. 1 is a block diagram illustrating a network system, in accordance with an embodiment of the invention;

FIGS. 2A, 2B and 2C together illustrate an example table of a furnishing database, in accordance with an embodiment of the invention;

FIG. 3A is a block diagram illustrating details of the design assistant of FIG. 1, in accordance with an embodiment of the invention;

FIG. 3B is a block diagram illustrating details of the design engine of FIG. 3A, in accordance with an embodiment of the invention;

FIG. 4 is a block diagram illustrating a computer system in accordance with an embodiment of the present invention;

FIG. 5A illustrates a first example dynamic structured query set, in accordance with an embodiment of the present invention;

FIG. 5B illustrates a second example dynamic structured query set, in accordance with an embodiment of the present invention;

FIG. 6A illustrates a first example combination, in accordance with an embodiment of the present invention;

FIG. 6B illustrates a second example combination, in accordance with an embodiment of the present invention;

FIG. 7A is a flowchart illustrating a first method of building the furnishings database of FIG. 1, in accordance with a first embodiment of the present invention;

FIG. 7B illustrates a model of a furnishings database structure, in accordance with an embodiment of the present invention;

FIGS. 8A and 8B together form a flowchart illustrating a method of using a design assistant; in accordance with an embodiment of the present invention;

FIGS. 9A and 9B together form a flowchart illustrating a method of searching a furnishings database, in accordance with an embodiment of the present invention;

FIG. 10 is a block diagram illustrating a network system, in accordance with an embodiment of the present invention;

FIG. 11 is a block diagram illustrating details of the server of FIG. 10, in accordance with an embodiment of the present invention;

FIG. 12 is a block diagram illustrating details of the PDA of FIG. 10, in accordance with an embodiment of the present invention;

FIG. 13 illustrates a PDA, in accordance with a second embodiment of the present invention;

FIG. 14 is a flowchart illustrating a method of assisting a customer with customer service, in accordance with an embodiment of the present invention; and

FIG. 15 is a flowchart illustrating a method of gathering scanned and requested information for internal use, in accordance with an embodiment of the present invention.

### DETAILED DESCRIPTION

The following description is provided to enable any person skilled in the art to make and use the invention, and is provided in the context of a particular application and its requirements. Various modifications to the embodiments will be readily apparent to those skilled in the art, and the generic principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

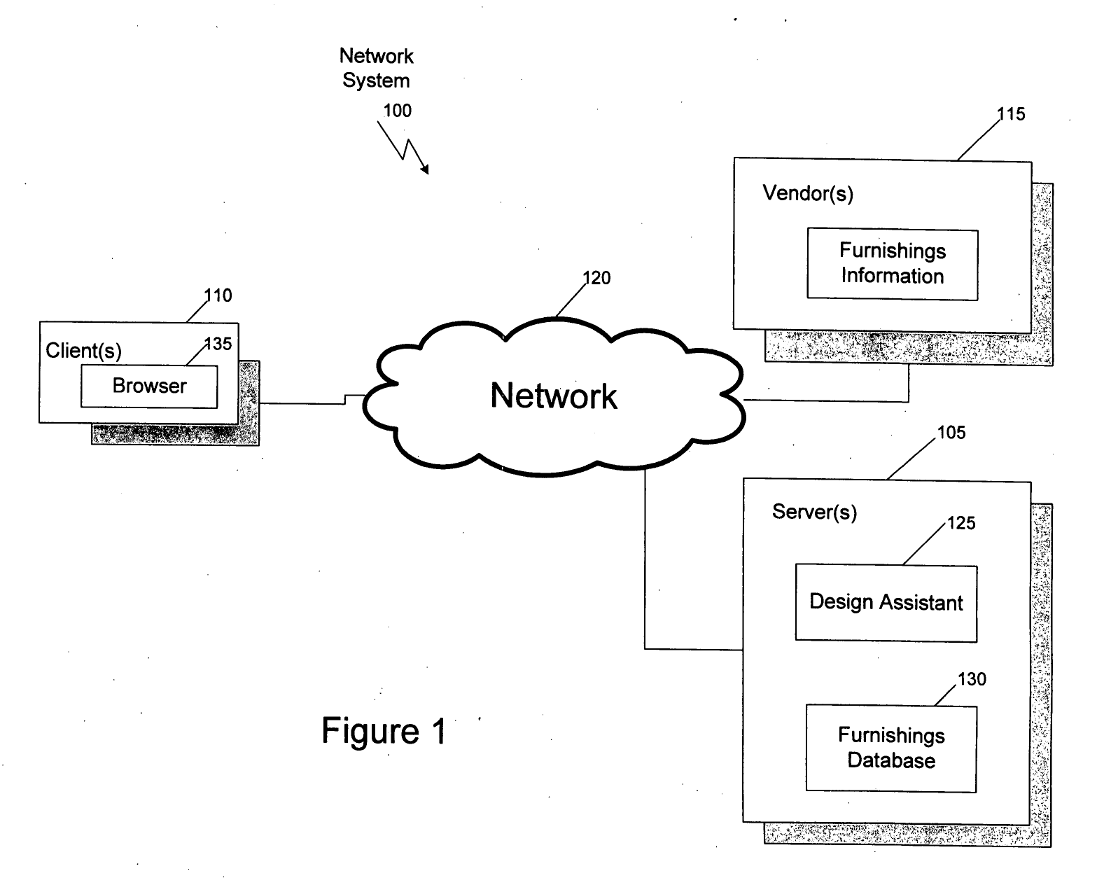

FIG. 1 is a block diagram illustrating a network system 100, in accordance with an embodiment of the invention. Network system 100 includes one or more servers 105, one or more clients 110 and one or more vendors 115, each coupled together via a computer network 120. Although the server(s) 105, client(s) 110 and vendor(s) 115 are each shown as including more than one, one skilled in the art will recognize that the system 100 can operate with as few as a single client 110 and a single server 105, each possibly operating on the same computer without a computer network 120 (e.g., a standalone application). For convenience, the description below refers to each of these devices in the singular case and operating remotely as three separate devices. One skilled in the art will recognize that the computer network 120 may be a local area network (LAN) or a wide area network (WAN) such as the WAN commonly referred to as “the Internet.”

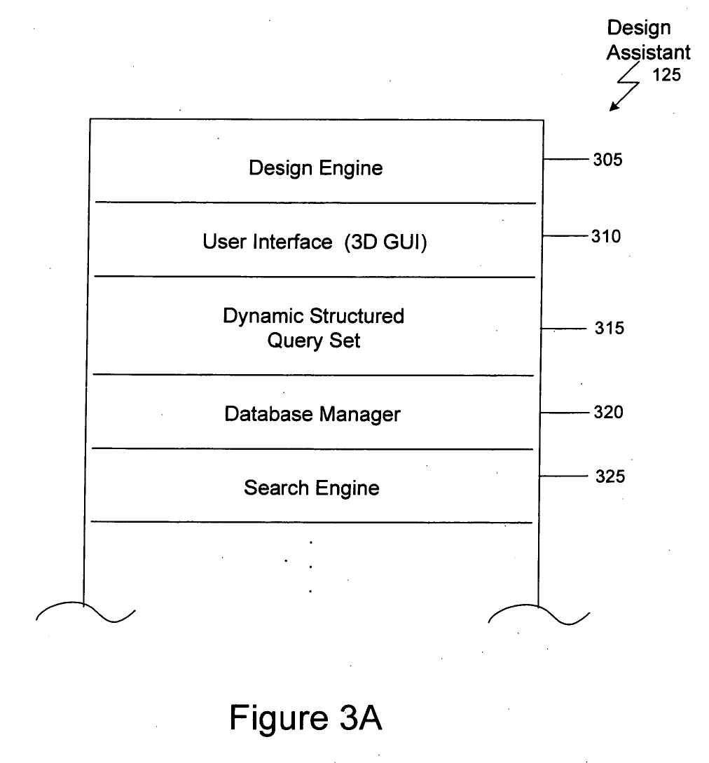

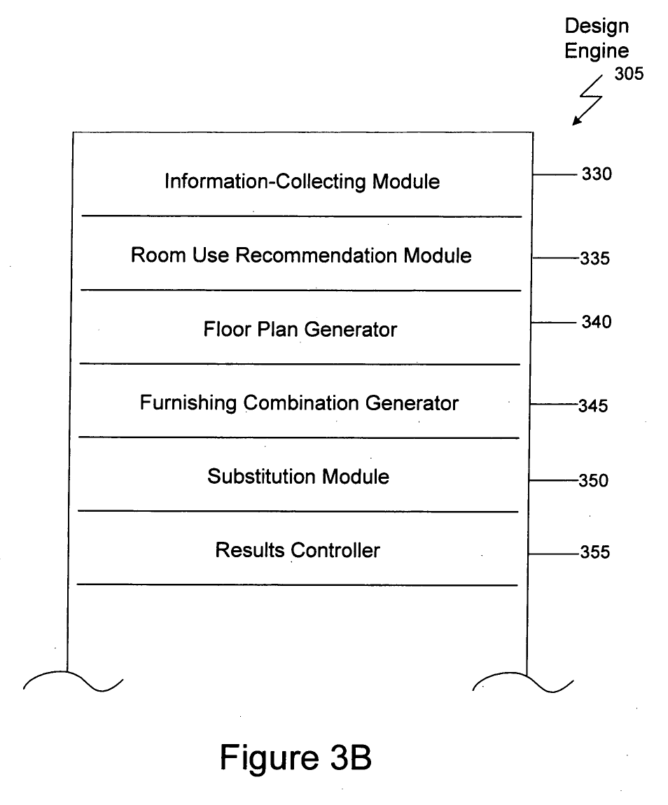

The server 105 includes a design assistant 125 and a furnishings database 130. The design assistant 125 receives room and preference information possibly from the client 110, and possibly in response to a series of questions posed by the design assistant 125 to the client 110. The design assistant 125 then uses the room and preference information, attribute information of various furnishings and/or designer guidelines to generate automatically a set of recommended floor plans, combinations of recommended furnishings, design and furnishing alternatives, etc. The design assistant 125 then enables the client 110 to modify the floor plans and/or furnishings combinations, to make selections, to purchase furnishings, etc. In one embodiment, the design assistant 125 automatically modifies (e.g., adjusts, narrows, adds, subtracts, etc.) the recommended floor plans, the recommended combinations of furnishings, the recommended styles and patterns, etc. based on selections made and/or preference information further indicated by the client 110. For example, if the client 110 indicates dissatisfaction of a particular item, e.g. a sofa, the design assistant 125 can discard all combinations with the item. The server 105 may be managed by a retail establishment, an interior designer, an exterior designer, a manufacturer, a wholesale establishment, a chain of stores, or other entity. The design assistant 125 will be described in greater detail with reference to FIG. 3.

For simplicity, the term “designer” is intended to include interior and/or exterior designers. The term “furnishings” or “products” is intended to include any design item, including furniture, floor treatments, wall treatments, countertop surfaces, yard surfaces, yard furniture, etc., whether intended for indoor or outdoor use, whether for commercial or residential spaces. The term “item”, “design item”, “piece”, “product” or “furnishing” is intended to include any single design item, e.g., an item of furniture, a floor treatment, a wall treatment, a countertop surface, a yard surface such as hardscape or softscape, a piece of yard furniture, etc. The terms “space”, “room” and “area” are all intended to cover the region intended for the new furnishings, whether indoor or outdoor, commercial or residential. The term “floor plan” is intended to include a recommended placement of furnishings, possibly including artwork location, wall treatments, etc.

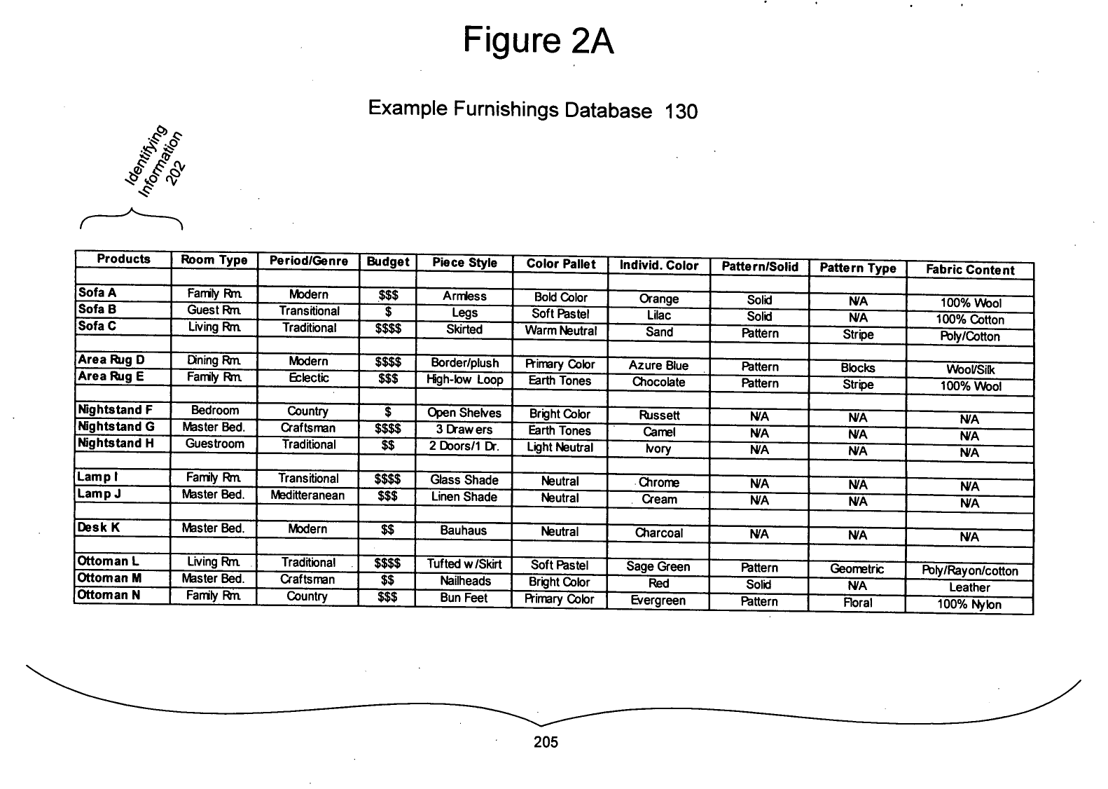

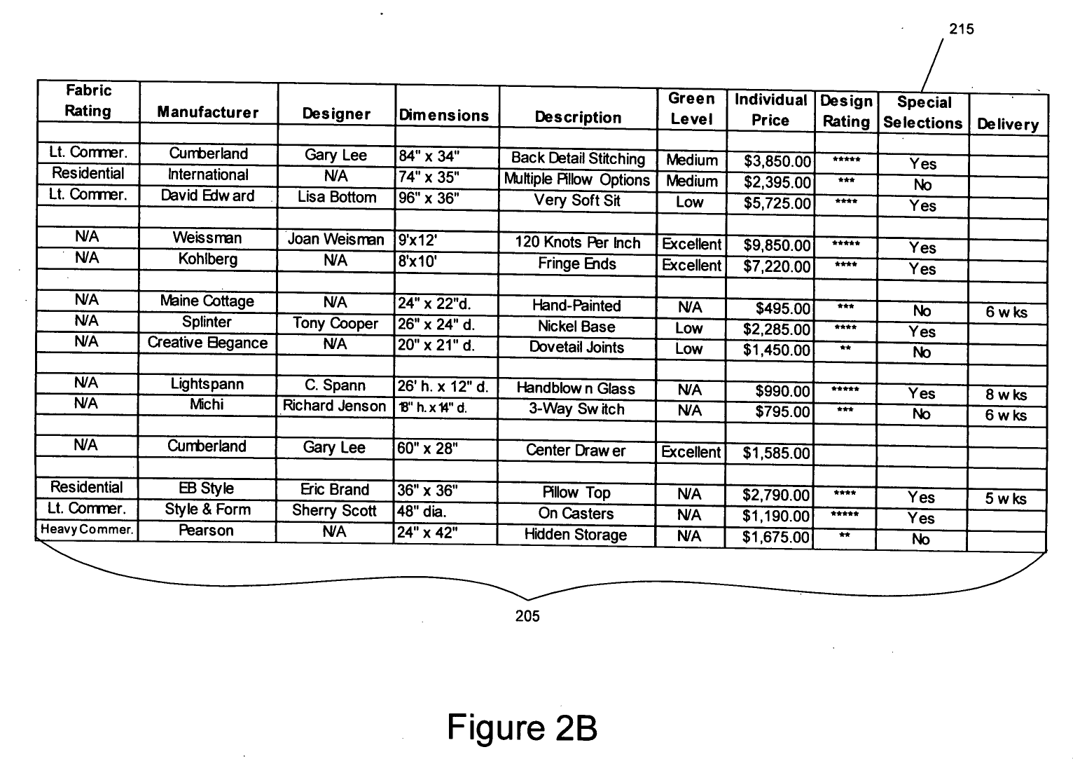

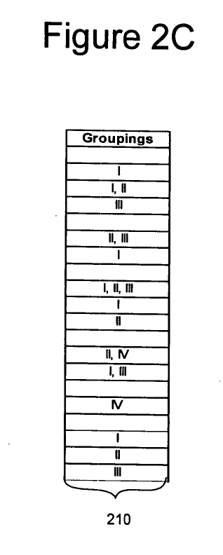

In this embodiment, the furnishings database 130 is configured to store furnishings information, including attribute information (e.g., style, color, price, purpose, period/genre, content such as fabric content, dimensions, etc.) of a vast number of furnishings, and to store grouping information (e.g., indications whether certain furnishings coordinate per a designer for an aesthetic fit). The groupings information is preferably determined by a designer on a product-by-product, pattern-by-pattern, etc. basis and indicates whether certain design items coordinate well according to this designer. To determine whether certain furnishings coordinate well, the design assistant 125 can apply either the attribute information or the grouping information or both. The furnishings database 130 is shown and described below with reference to FIGS. 2A-2C.

Assuming that the client 110 wishes assistance with the interior design of a family room of certain dimensions and object (window, door, moldings, built-in cabinetry, etc.) locations, the design assistant 125 will search the furnishings database 130 for combinations in accordance with user-defined preferences (e.g., modem, inexpensive, bright colors, etc.). Based on its findings, the design assistant 125 will recommend certain combinations of furnishings, e.g., coffee tables, sofas, end tables, lamps, electronics centers, etc.

The client 110 includes a browser 135 or any software for communicating with the design assistant 125. In the case of a stand-alone application, the client software (i.e., the client 110) for communicating with the design assistant 125 is the stand-alone design assistant's user interface. The client 110 may be operated by an in-store sales associate, a user of a remote computer, an in-store customer, etc.

FIGS. 2A-2C together form an example furnishings database 130, in accordance with an embodiment of the present invention. Although the furnishings database 130 is shown as a table, one skilled in the art will recognize that other structures can be used to store the furnishings information. The furnishings database 130 includes design item identification information 202, attribute information 205 and grouping information 210. As can be seen by the column headings, the attribute information 205 includes product type, room type, period/genre, budget level, piece style, color palette, individual color, pattern/solid, pattern type, fabric content, fabric ratings, manufacturer identification, designer, dimensions, green level (i.e., an indication of the level of environmental soundness), individual price, design rating, and delivery schedule. The special selections 215 column indicates whether the item is a particularly preferred item of the designer, for example, is in high fashion, is likely to match a larger variety of furnishings, is just a favorite, etc. Other attribute information 205, such as alternative color options, alternative fabric options, etc., can also be stored. Further, the color columns may indicate a design item's base color, may indicate every color, may indicate the primary colors within the design, etc. The values for the various attributes of attribute information 205 may be defined by one or more designers or by the furnishing manufacturers. In this embodiment, the groupings information 210 is included in the last column of the furnishings database 130. The grouping information 210 is preferably defined by one or more experienced designers, identifying which design items coordinate well together.

For example, as can be seen from the example furnishings database 130, sofa A and area rug E are both recommended for family room use. (See the “room type” column.) However, sofa A is defined as a traditional type piece, and area rug E is defined as an eclectic type piece. (See the “period/genre” column.) Accordingly, although both are intended for the same interior space, these two design items likely do not coordinate well according to the attribute information 205. In one embodiment, the attributes of sofa A and area rug E can be compared to determine a coordination score (e.g., a percentage). This coordination score may be used to identify coordinating combinations and to organize the combination recommendations. As the furnishings database 130 reaches thousands of products, the attribute information 205 will likely have several combinations of design items deemed coordinating per the attribute information 205, or several design items deemed coordinating at a particular coordination score.

Now, referring to grouping information 210, sofa A and area rug E are identified as coordinating. (See the “groupings” column.) This essentially means that the designer subjectively believes that these two pieces coordinate well, regardless of the coordination score per the attribute information 205.

As stated above, the design assistant 125 may review attribute information 205 and/or groupings information 210 to determine coordinating products. That is, the design assistant 125 may analyze only one of attribute information 205 or groupings information 210, may examine both attribute information 205 and grouping information 210 to determine coordinating products, or may review both but offer combinations that satisfy either attribute information 205 or grouping information 210. The procedure for determining furnishing coordination may be set within the design assistant 125 or may be set and/or reset by the client 110 (if, for example, there are too many combinations possible). For example, the client 110 may request only combinations that score greater than 85% AND are deemed coordinating according to the grouping information 210. If only two combinations are identified, the user 110 may reduce his or her standards so that more alternatives are presented.

FIG. 3A is a block diagram illustrating details of the design assistant 125, in accordance with an embodiment of the present invention. The design assistant 125 includes a design engine 305, a user interface 310, a dynamic structured query set 315, a database manager 320, and a search engine 325. Access to the design assistant 125 may be presented to the client 110 via a link from a retail website or a website dedicated to the service, via a DVD ROM, etc.

In this embodiment, the design engine 305 includes the rules for . . .

(1) obtaining room information and user preferences;

(2) recommending use alternatives for a space;

(3) suggesting floor plans;

(4) selecting furnishing combinations;

(5) enabling substitutions;

(6) updating furnishing selections based on client activity.

(1) Obtaining User Requirements and Preferences

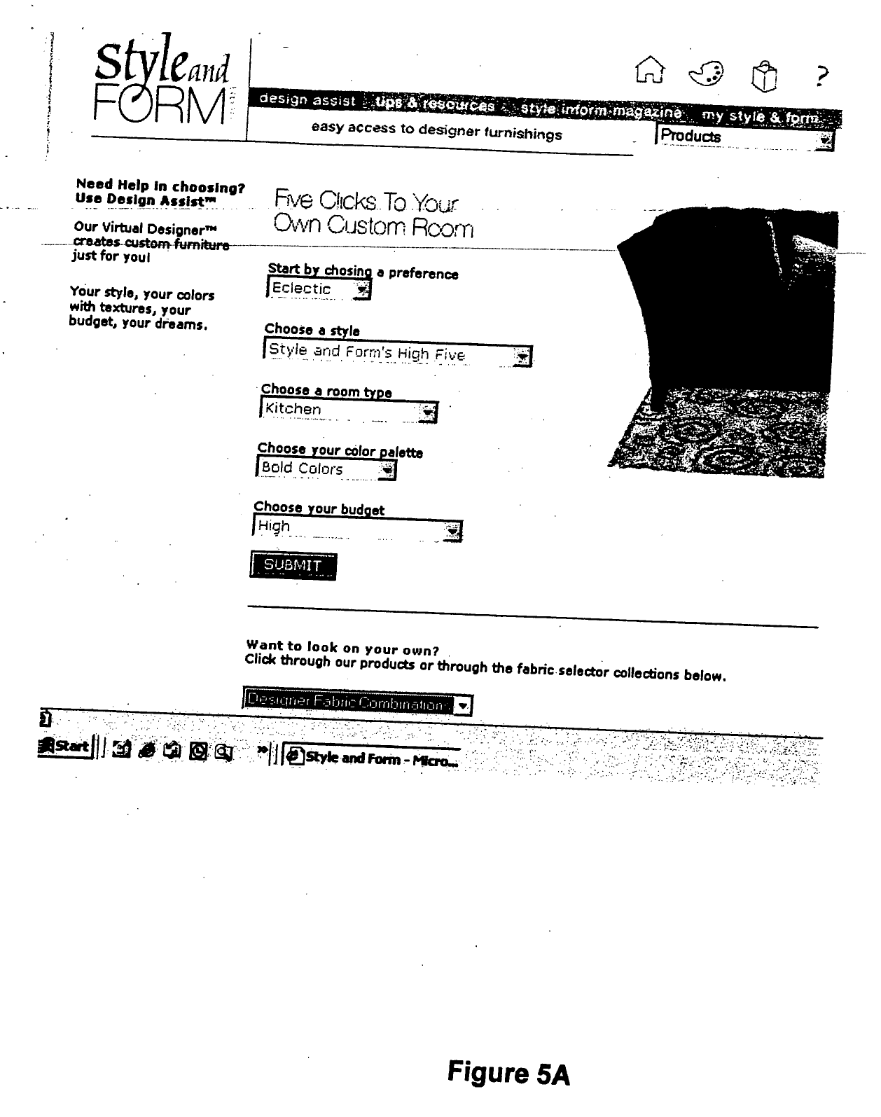

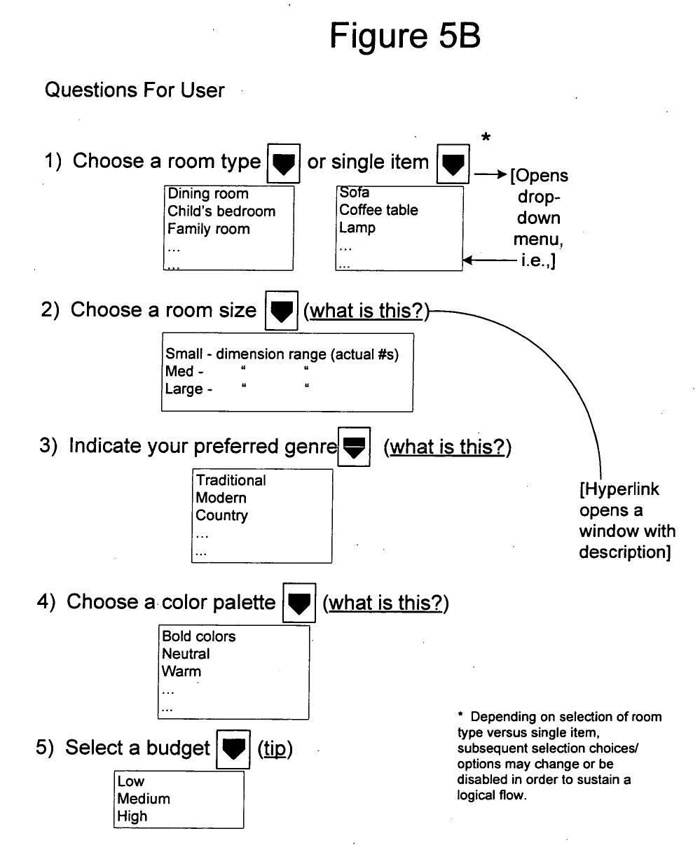

In this embodiment, the design engine 305 begins by obtaining room information and user preferences. An example module for performing this feature is the information-collecting module 330 of FIG. 3B. The information-collecting module 330 operates with a user interface 310 and a dynamic structured query set 315. The information-collecting module 330 retrieves the dynamic structured query set 315, which in this embodiment includes a series of questions to pose to the client 110. Two example dynamic structured query sets 315 are shown in FIGS. 5A and 5B. FIG. 5A illustrates a first example set of initial questions, namely, the preferred period/genre (e.g., eclectic, traditional), the preferred style (e.g., High Five's), the preferred room type (e.g., kitchen, family room), the preferred color palette (e.g., bold, neutral, warm), and the preferred budget (e.g., high, medium, low). FIG. 5B illustrates a second example set of initial questions, namely, a room type, a room size (e.g., small, medium, large or exact dimensions), a period/genre, a color palette, and a budget. FIG. 5B also offers the selection of single item searches as an alternative to the design of a space. The single item search may be implemented by enabling the client 110 to browse the furnishings database 130 or by making a single item recommendation in response to search queries, e.g., current floor plan, current furnishings, space available, style preferences, budget, etc. If in response to search queries, the design engine 305 may determine the coordinating design items based on the same coordination principles as those for an entire space. One skilled in the art will recognize that the design engine 305 can assist the client 110 to find any number of pieces.

Questions indirectly related to the user preferences for the space may also be asked of the client 110. For example, the dynamic structured query set 315 may include questions regarding rooms already existing, functional uses desired, marital status, number and age of children, etc. By learning about the client 110, the information-collecting module 330 will be in a better position to offer alternative uses for a room (e.g., game room, workout room, formal dining room, etc.), to offer recommended materials, whether any artwork should be attached higher (so that children cannot reach it), to offer furnishing combinations, etc.

(2) Recommending Use Alternatives for a Space

After learning about the room dimensions and user preferences, the design engine 305 may offer the client 110 a set of alternatives uses for a space. An example module for performing this features is the room use recommendation module 335 of FIG. 3B. For example, if the room use recommendation module 335 learns that the client 305 is married, has no kids, has a living room, family room, bedroom, guest bedroom, and one interior space scheduled for interior design, the room use recommendation module 335 may offer the client 110 options such as a game room or formal dining room. Further, if the room is sufficiently large, the room use recommendation module 335 may recommend a combined game room and exercise room. The room use recommendation module 335 can implement rule sets that generate available options given the answers to certain input variables. Alternatively, the room use recommendation module 335 can offer the client 110 to select from a wide variety of alternative room uses, e.g., a list of all reasonable room uses. Based on the room size, the room use recommendation module 335 may indicate that the client 110 can select more than one use.

The room use recommendation module 335 can rate the possible uses of the space. That way, when the room use recommendation module 335 offers alternatives, it can offer them in order of room use score. Room use score can be based on rooms currently in the home, e.g., a second guest room may not rate as highly as an exercise room for a single active person. Room use score can be also based on room attributes, such as whether the size of the room meets certain standards for its selected purpose. For example, a room of 10′×8′ will likely be too tight for a master bedroom but may be ideal for a game room. Further, room use score can be based on general designer guidelines. One skilled in the art will recognize that room use scoring can be based on a vast number of variables.

It will be appreciated that the singular form of the term “use” as in “recommend a use for a space” is intended to include single and/or multiple use options. The term “single use” as in “recommend a single use for a space” is intended to include only single use options. Like many features of the present embodiment, the feature of recommending a room use is optional.

(3) Suggesting Floor Plans

After the client 110 indicates (e.g., selects) a room use, the design engine 305 suggests floor plans. An example module for performing this feature is the floor plan generator 340 of FIG. 3B. In a rules-based embodiment, the floor plan generator 340 begins by obtaining a list of general (typical) furnishings for the intended room use. For example, if the intended use for the space is a family room, the floor plan generator 340 will consider 1-2 sofas, 1-2 love seats, 1-2 chairs, 1-2 ottomans, 1-2 lamps, 1 television, 1 entertainment center, 2-3 end tables, 1-2 coffee tables, etc. Based on the information provided (e.g., room size, object locations, functional uses, etc.), the floor plan generator 340 will apply general designer guidelines, e.g., floor plans that maximize the use of space, do not impede ingress and egress, maximize natural light, do not impede objects, achieve the desired functional use, etc. The floor plan generator 340 will also prioritize the furnishings in the list of furnishings to determine which furnishing and how many of each furnishing can be included. For example, a small family room of about 18′×12′ will not be able to hold more than 1 sofa, one chair, 1 television; 2 end tables, and two lamps. However, a larger family room of about 25×30 will be able to hold more furnishings. Based on these guidelines, the floor plan generator 340 can rate the quality of each floor plan and accordingly may list the floor plan options in order of quality. Further, when determining the floor plan, the floor plan generator 340 may also select general dimension ranges for each of the design items.

In a template-based embodiment, the floor plan generator 340 may select from a predetermined set of floor plan templates to determine which of the floor plan templates work with the given space. The predetermined set of floor plan templates may be designed by a designer to incorporate various space dimensions, object locations including windows and doors, etc. The floor plan templates may be presented in a floor plan image gallery.

The floor plan generator 340 may enable the client 110 to modify a selected floor plan, e.g., by enabling the client 110 to increase the size of a table, remove an end table, move the sofa, etc. In a first embodiment, a modification of the floor plan itself or a modification of an attribute of a particular design item in the floor plan may affect the size, position, etc. of the other design items of the floor plan. This may be reflected in the 3D image provided to the user. In a different embodiment, the client 110 is allowed to make modifications despite the general designer guidelines (other design items may not change size, position, color, etc. Whether the floor plan changes automatically with client modifications of individual items and/or locations may be based on application preferences.

(4) Selecting Furnishing Combinations

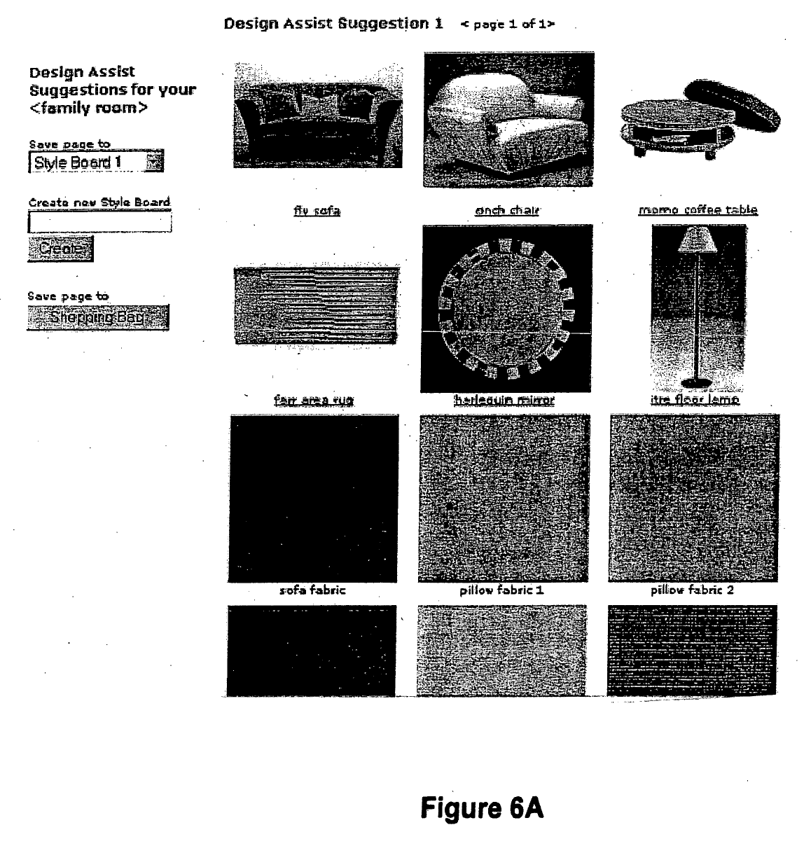

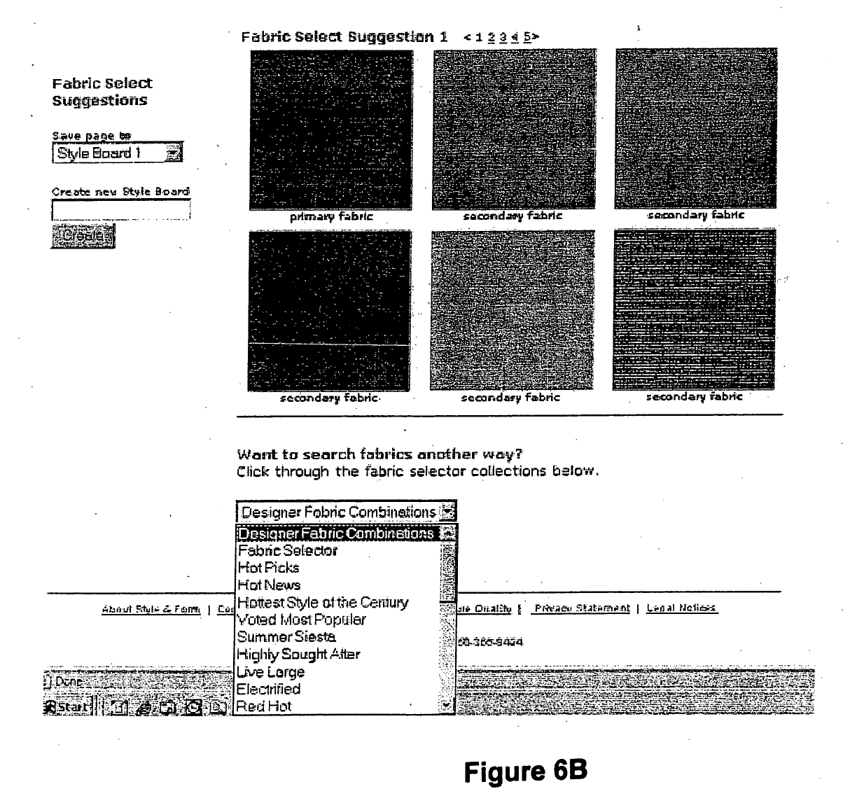

After the client 110 selects a floor plan (i.e., an arrangement of design items), the design engine 305 determines furnishing combinations. An example module for performing this feature is the furnishing combination generator 345 of FIG. 3B. In coordination with the search engine 325, the furnishing combination generator 345 searches the furnishings database 130 in accordance with the room information and user preferences of the client 110. The furnishing combination generator 345 may review attribute information 205 and/or groupings information 210 to determine which design items needed to accomplish the floor plan selected in section (3) coordinate and to determine possibly their coordination scores. In one embodiment, if the client 110 in section (3) above selected a floor plan that calls for 1 sofa, 1 chair, 1 coffee table, 1 rug, 1 mirror and 1 lamp, the furnishing combination generator 345 may begin with a single item, e.g., the sofa. In this example, the furnishing combination generator 345 will search the attribute information 205 of the furnishings database 130 for all sofas that substantially match the floor plan and user preferences (period/genre, style, color palette, etc.). Then, based on grouping information 210 and/or on attribute information 205, the furnishing combination generator 345 generates possible furnishing combinations with each sofa. One such example of a recommended combination of design items is shown in FIG. 6A. FIG. 6A shows a fly sofa, a cinch chair, a Momo coffee table, a Farr area rug, a harlequin mirror, a floor lamp and 6 matching fabric choices.

The furnishing combination generator 345 may score furnishing combinations. After it is determined which pieces will be selected for a room, combinations of these pieces can be determined. Based on a comparison of the attributes of the combinations, the furnishing combination generator 345 can compute a coordination score (e.g., a percentage). This coordination score may be used to determine recommended combinations, and to order the combination recommendations. It will be appreciated that each attribute need not be of equal priority. For example, style may be deemed more important than fabric content. And, fabric content may be deemed more important than manufacturer name. The coordination score can be determined based on the matching values of each attribute and on each attribute's value.

(5) Enabling Substitutions

Each piece and/or attribute may be substituted for other pieces and/or attributes. An example module that enables this feature is the substitution module 350 of FIG. 3B. In one example, there may be 4 lamps that match a particular sofa. Accordingly, the furnishing combination generator 345 may recommend a first lamp, and the substitution module 350 may enable the client 110 to substitute any of the other 3 lamps for the first lamp. Alternatively, the substitution module 350 (in coordination with the furnishing combination generator 345) may determine that 2 of the 4 lamps do not match the coffee table that matches the sofa, and accordingly will offer only the 2 lamps as alternatives. Many other search and substitution permutations are possible. FIG. 6B illustrates a set of 6 coordinating fabric choices (attributes) from which the client 110 can select.

In a different embodiment, the substitution module 350 may enable the client 110 to select any alternative or from various alternatives, some of which may not coordinate well. At times, a client 110 may request a substitution for a design item that does not coordinate with other pieces, e.g., the client 110 may select a traditional lamp with a modern sofa. At times, a client 110 may modify an item such that it no longer coordinates with the given space, e.g., the client 110 may increase the height of a bookcase, which now will block a window. In one embodiment, the substitution module 350 may politely inform the user via the user interface 310 that such modification would not be recommended and may provide reasoning. In the case of the lamp, the substitution module 350 may inform the client 110 that the traditional lamp will detract from the modern feel of his home. In the case of the bookcase resizing, the substitution module 350 may inform the client 110 that the bookcase will block valuable light, will be unattractive from both the street and within the room, etc. In another embodiment, however, the substitution module 350 will allow the client 110 to make any substitution requested, regardless of coordination, since the customer is always right. Further, for convenience, the design engine 305 may retain discarded information for possible future use.

(6) Updating Furnishings Selections Based on Client Activity

As the client 110 makes selections and substitutions, the design engine 305 may update the available combinations and recommended substitutions. An example module for performing this feature is the results controller 355 of FIG. 3B. For example, if the client 110 selects a particular sofa, fabric and color, the results controller 355 may discard all design items that do not coordinate with this particular sofa, fabric and color. This technique would assist the client 110 by narrowing the scope of his search.

The database manager 320 enables the designer to add additional furnishings to the furnishings database 130, to modify or enter attribute information 205, to modify or enter grouping information 210, to remove furnishings from the furnishings database, etc.

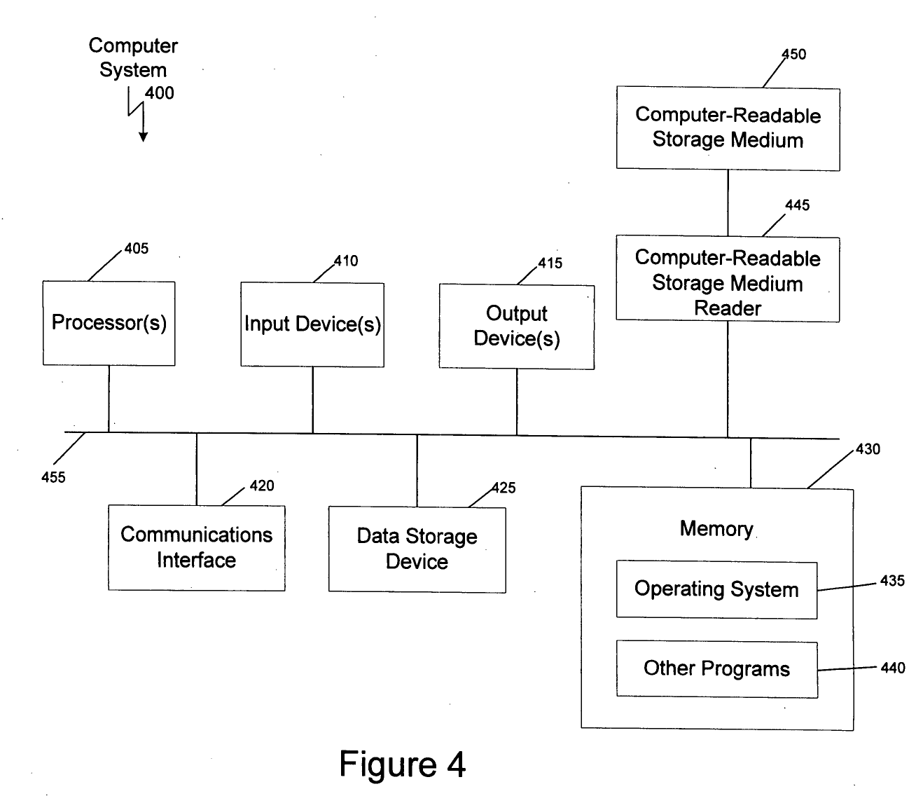

FIG. 4 is a block diagram illustrating details of an example computer system 400, wherein each of client 110, server 125, and vendor 115 is an instance of computer system 400. Computer system 400 includes a processor 405, such as an Intel Pentium® microprocessor or a Motorola Power PC® microprocessor, coupled to a communications channel 455. The computer system 400 further includes an input device 410 such as a keyboard or mouse, an output device 415 such as a cathode ray tube display, a communications device 420, a data storage device 425 such as a magnetic disk, and memory 430 such as Random-Access Memory (RAM), each coupled to the communications channel 455. The communications interface 420 may be coupled to a network such as the wide-area network commonly referred to as the Internet. One skilled in the art will recognize that, although the data storage device 425 and memory 430 are illustrated as different units, the data storage device 425 and memory 430 can be parts of the same unit, distributed units, virtual memory, etc.

The data storage device 425 and/or memory 430 may store an operating system 435 such as the Microsoft Windows NT or Windows/95 Operating System (OS), the IBM OS/2 operating system, the MAC OS, or UNIX operating system and/or other programs 440. It will be appreciated that a preferred embodiment may also be implemented on platforms and operating systems other than those mentioned. An embodiment may be written using JAVA, C, and/or C++ language, or other programming languages, possibly using object oriented programming methodology.

One skilled in the art will recognize that the computer system 400 may also include additional information, such as network connections, additional memory, additional processors, LANs, input/output lines for transferring information across a hardware channel, the Internet or an intranet, etc. One skilled in the art will also recognize that the programs and data may be received by and stored in the system in alternative ways. For example, a computer-readable storage medium (CRSM) reader 445 such as a magnetic disk drive, hard disk drive, magneto-optical reader, CPU, etc. may be coupled to the communications bus 455 for reading a computer-readable storage medium (CRSM) 450 such as a magnetic disk, a hard disk, a magneto-optical disk, RAM, etc. Accordingly, the computer system 400 may receive programs and/or data via the CRSM reader 445. Further, it will be appreciated that the term “memory” herein is intended to cover all data storage media whether permanent or temporary.

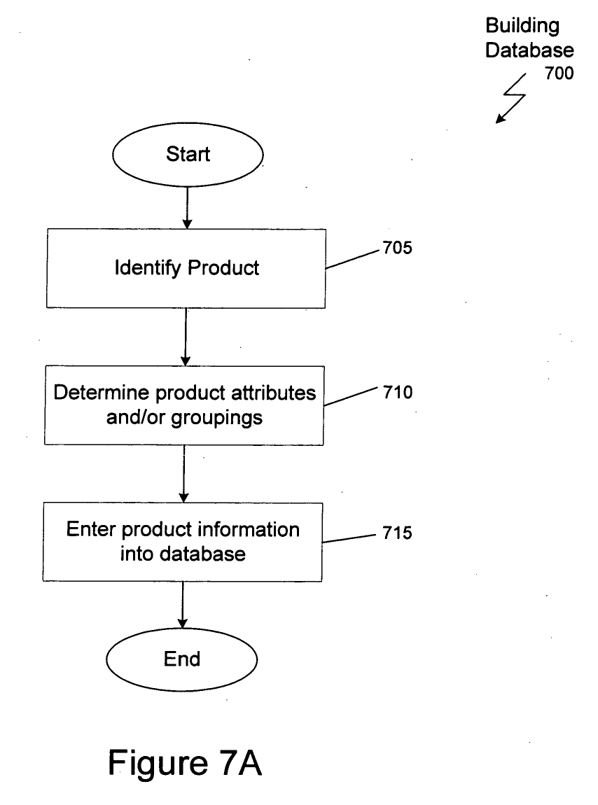

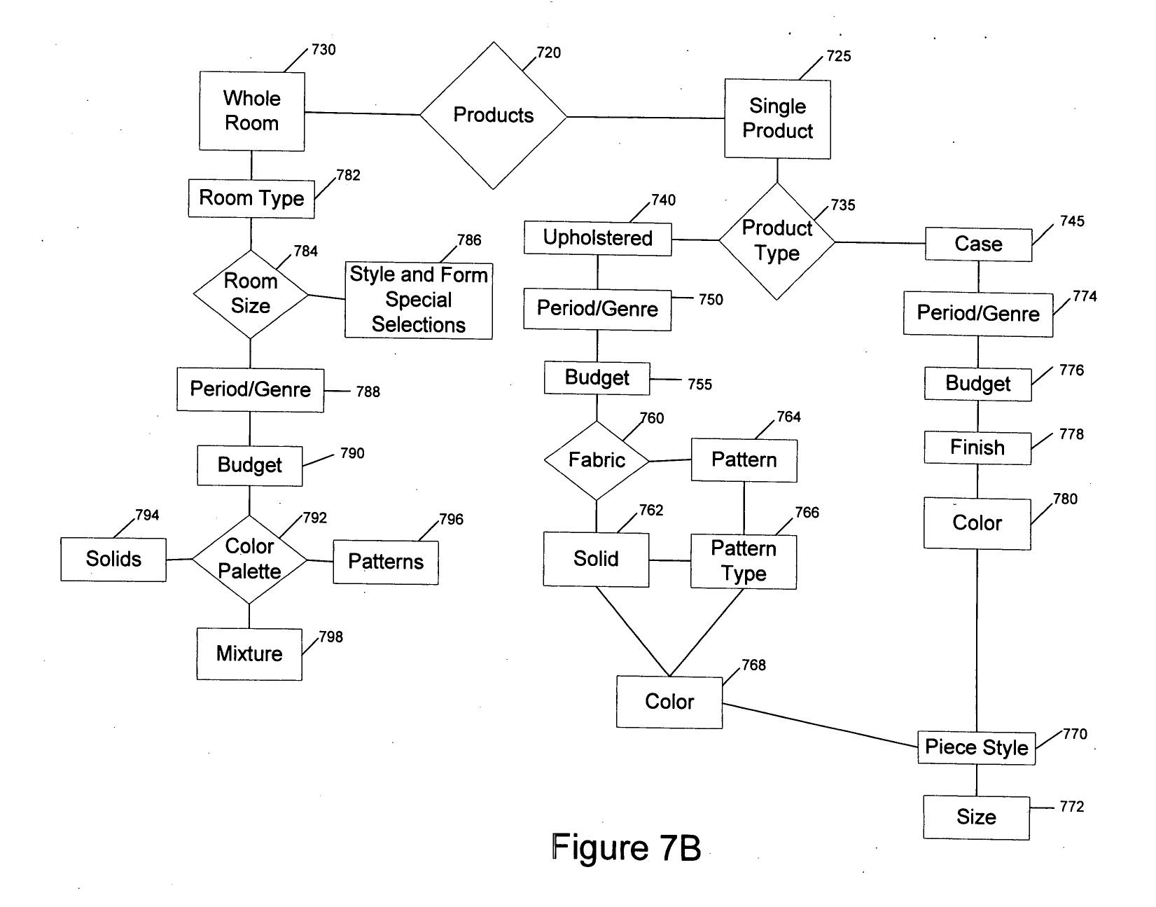

FIG. 7A is a flowchart illustrating a method 700 of building the furnishings database 130. Method 700 begins in step 705 with the designer or alternatively a manufacturer identifying a product to be included in the furnishings database 130. The designer (or possibly the manufacturer) in step 710 determines the product attribute information 205 and/or groupings information 210. The designer, manufacturer or a data entry person via the user interface 310 in step 715 can enter the information into the furnishings database 130. Method 700 then ends.

FIG. 7B illustrates a structural model 700 of a furnishings database, e.g., furnishings database 130, in accordance with an embodiment of the present invention. The structural model 700 illustrates an example hierarchical relationship of attributes 205 and furnishings. The structural model 700 preferably maximizes efficiency of use and information filtering.

In this embodiment, furnishings database structure 700 divides products 720 into single products 725 and whole room products 730. Single products 725 are divided by product types 735 into upholstered products 740 and case products 745. Upholstered products 740 have attributes 205 for period/genre 750, budget class 755, and fabric options 760 divided into patterns 764 with pattern type 766 and solids 762. Both patterns and solids have a color 768, a style 770 and a size 772. Case products 745 have a period/genre 774, a budget class 776, a finish 778, a color 780, a style 770 and a size 772.

Further, in this embodiment, whole room products 730 have a room type 782 and a room size 784. The room size 784 may identify special selections 215 for floor plans and furnishing combinations 786. Whole room products 730 also have a period/genre 788, a budget class 790, and a color palette 792. The color palette 792 may be divided into solids 794, patterns 796 and a mixture 798 of solids and patterns. Of course, other structural models are also possible.

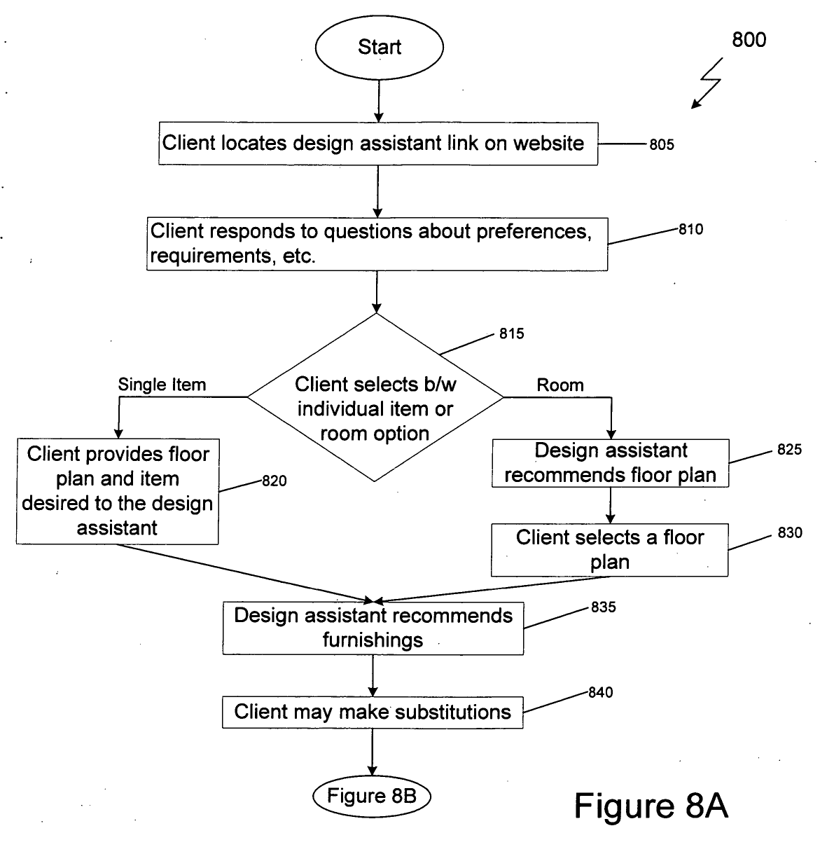

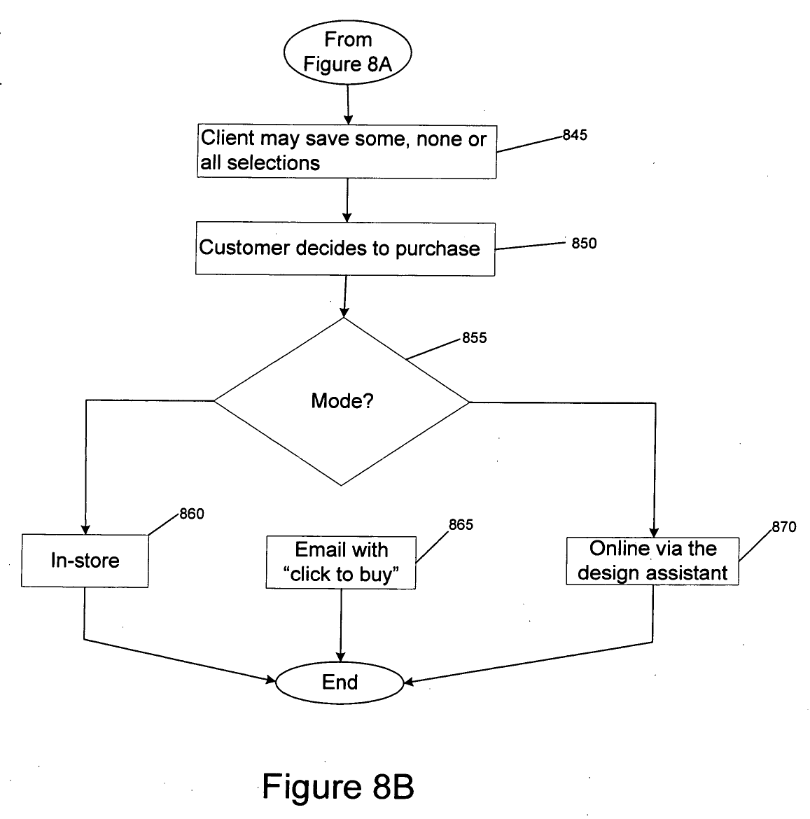

FIGS. 8A and 8B, together, form a flowchart illustrating a method 800 of using the design assistant 125 to assist a client 110 with the design of a space, in accordance with an embodiment of the present invention. Method 800 begins with the client in step 805 initiating the design assistant 125 application, e.g., by using the browser 135 to locate the design assistant 125 link on a website. The client 110 in step 810 responds to a set of questions regarding the customer's preferences, room requirements, etc. In step 815, the client 110 selects between possible modes of assistance, e.g., purchasing a single item or requesting assistance for the design of a room (possibly with pieces already). In single item mode, method 800 jumps to step 820 where the client 110 may browse furnishings of the desired type (not shown), or provide a current floor plan and information regarding the specific item desired, e.g., a chair in the living room already furnished substantially, to the design assistant 125. In room mode, method 800 jumps to step 825 where the design assistant 125 recommends certain floor plan options, e.g., based on information provided about the customer and the customer's space. Alternatively, although not shown, the client 110 may select from a set of floor plan template alternatives, as described above. In step 830, the client 110 indicates, e.g., selects, a floor plan (possibly via multiple iterations with the design assistant 125).

It will be appreciated that, if the client 110 already owns certain items and wants the design assistant 125 to assist with furnishing selection, pictures of the items may be uploaded to the design assistant 125. The pictures may be provided in a predetermined format, e.g., jpeg. The relevant items in the pictures may be identified by user input, by designer input, by intelligent software that recognizes items within the picture, etc. The relevant attributes of the items in the pictures may be determined by the designer, by the client, or by the software. It will be further appreciated that the design assistant 125 may not be able to learn or obtain all possible attributes 205 of the relevant items. For example, the design assistant 125 may only be able to capture automatically attributes 205 such as color, color palette, fabric, etc. It may not be able to capture attributes such as period/genre, budget, etc. The client and/or designer may have to input this information, if available. It will be appreciated that the desired item may then be compared against the uploaded item for coordination. A coordination determination will likely be implemented using the gathered attribute information 205, unless the existing piece is in the database and grouping information 210 for the item exist.

It will be further appreciated that, in single item mode, the floor plan need not be provided if the client 110 is merely going to browse the furnishings database 130. Further, in single item mode, the design assistant 125 may request other information from the client 110 (in addition to or instead of floor plan design) before offering furnishing recommendations. For example, the design assistant 125 may ask for furnishing type desired, approximate dimensions of furnishing desired, style desired, etc. or combinations of the same. It will be appreciated that, in one embodiment, when the client 110 wants the design assistant 125 to assist with floor plan design of a section of a room, the client 110 may choose room mode (inputting room objects and furnishings (possibly as other objects) that essentially cannot be moved).

Whether in single item or room mode, the method 800 then continues to step 840. The design assistant 125 in step 840 recommends furnishing or furnishing combinations based on the information provided. Furnishing recommendations may be implemented in the manner described with reference to FIG. 3. The client 110 in step 840 may make substitutions and in step 845 may store some, all or none of the selections.

The customer in step 850 decides to purchase some or all of the selections, and in step 855 decides on a mode to make the purchase. In this embodiment, method 800 allows the client 110 to make the purchase either in step 860 via an in-store purchase, in step 865 via an email sent to the client 110 with a “click-to-buy” link, or in step 870 via an online transaction via the design assistant 125. Although not indicated, one skilled in the art will recognize that the client 110 can jump to the step of purchasing an item at any time. Method 800 then ends.

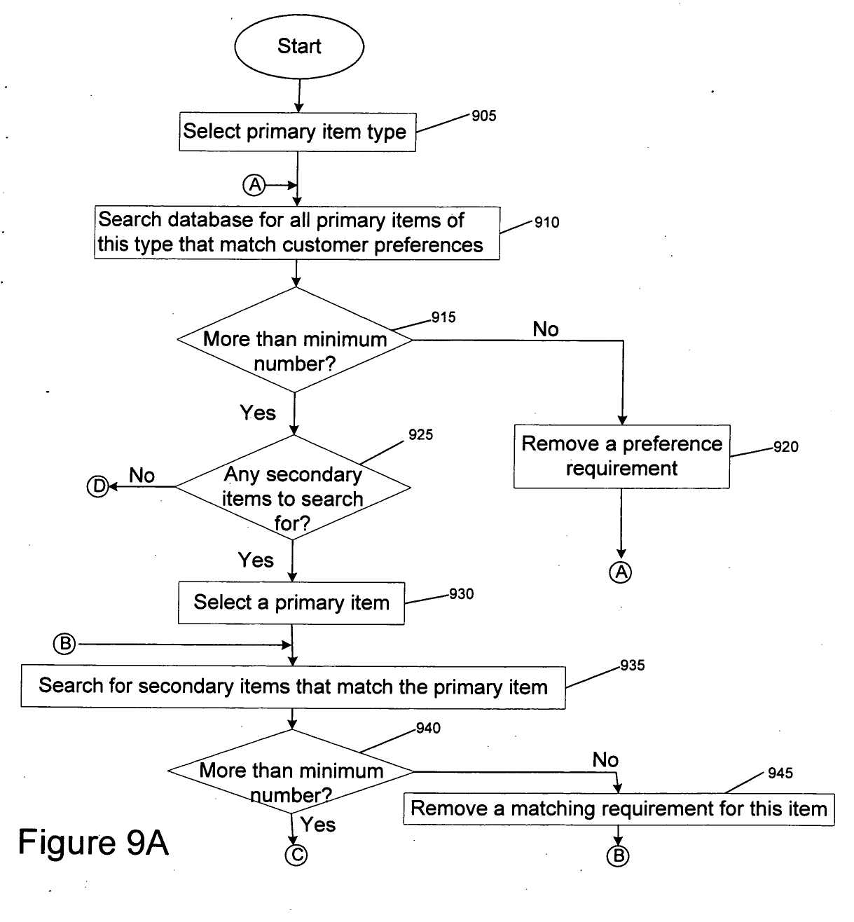

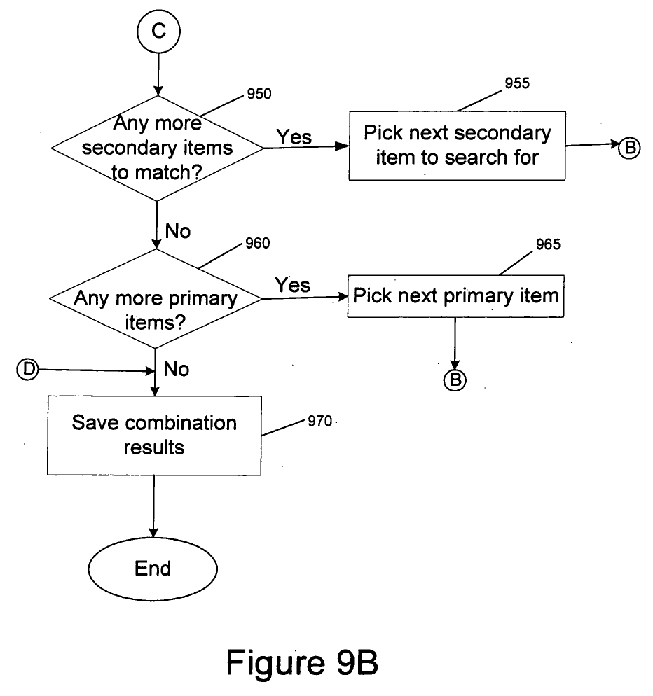

FIGS. 9A and 9B, together, form a flowchart illustrating a method 900 of searching the furnishings database 130 for furnishing recommendations, in accordance with an embodiment of the present invention. Method 900 begins with the design engine 305 (via the search engine 325) in step 905 selecting a primary item type. In the case of single item mode (e.g., requesting a recommendation for only a sofa), the primary item type will be the same as the type of the single item (e.g., a sofa). In the case of room design mode, the primary item should be selected from the items needed to satisfy the floor plan. As the primary item, the design engine 305 may be configured to select the item generally most difficult to fit, the item generally most difficult to find, the item generally most important, the item most costly, the largest item, etc. For example, if the customer is designing a living room, the primary item type may be a sofa and not an end table. Alternatively, the client 110 can be prompted to select the primary item type. Although not shown, it will be appreciated that a client 110 can jump between single item mode and room mode, e.g., by selecting single item mode, selecting an item, and then requesting coordinating pieces. Other embodiments are certainly possible.

The design engine 305 in step 910 searches the furnishings database 130 for all primary items of the selected type that match the floor plan and customer's preferences. The design engine 305 will try at this time to satisfy all room requirements and all customer preferences, e.g., a sofa of XYZ dimensions, of traditional style, of a particular budget, of a neutral color palette, etc. In this embodiment, the design engine 305 in step 915 then determines whether there are a minimum number of matching items, e.g., at least one, in the furnishings database 130. If not, then the design engine 305 in step 920 removes one of the customer preferences (preferably, one of lesser importance, e.g., fabric content) and returns to step 910 to search the furnishings database 130 for all primary items matching the remaining preferences. One skilled in the art will recognize that alternative techniques can be used. For example, the design engine 305 can compare and score all items of the desired type, e.g., all sofas. Then, the design engine 305 may present only those achieving a particular score or may present only a specified number of those having the highest scores.

If the design engine 305 in step 915 determines that there is a minimum number of items in the resulting set of primary items located, then the design engine 305 in step 925 determines if there are any secondary items to search for. The term “secondary items” is being used to include all items of item types needed (in the room mode, per the floor plan) other than the primary item type. For example, if the customer needs a sofa, two end tables and a coffee table, then the design engine 305 may select the sofa as the primary item and the two end tables and coffee table as the secondary items. If not, then method 900 jumps to step 970 to save the combination results. Method 900 then ends. In another embodiment, the client 110 may pick a first item, e.g., a desired coffee table, and then select an option on the site to find coordinating pieces. The first item selected by the client 110 (namely, the coffee table) will be selected by the design assistant 125 as the primary item. The coordinating pieces will be the secondary items. In this embodiment, the method 900 will essentially start from step 925 to determine secondary items.

If the design engine 305 in step 925 determines that there are secondary items to search for, then the design engine 305 in step 930 selects one of the primary items, and in step 935 selects a secondary item type to search for and searches for all secondary items that coordinate with the primary item. It will be appreciated that this includes matching the secondary items to the floor plan, the customer preferences and the primary item selected. The secondary items may be prioritized so that they are selected in a particular order.

The design engine 305 in step 940 determines whether a minimum number of secondary items have been identified. Again, as stated above, coordination scoring techniques can additionally or alternatively employed. If not, then the design engine 305 in step 945 removes a matching requirement, e.g., one of the customer's preferences or one of the attributes of the primary item. The design engine 305 returns to step 935 to search for secondary items that match the remaining requirements.

If the design engine 305 finds a minimum number of secondary items that match the floor plan, the customer preferences and the primary item, then the design engine 305 in step 950 determines if there are any more secondary items to match. If so, then the design engine 305 in step 955 selects another secondary item type and returns to step 935 to search for any secondary items of this type that matches the floor plan, the customer preferences, the primary item selected and any secondary items selected. It will be appreciated that matching the secondary items to the primary item may be implemented by attribute information 205 comparison or by groupings information 210. This loop will continue until all secondary item combinations with this primary item are determined.

If the design engine 305 in step 950 determines that no more secondary items exist, then the design engine 305 in step 960 determines if there are any more primary items to coordinate with the secondary items. If so, then the design engine 305 in step 965 picks the next primary item and returns to step 935 to determine if there are any secondary items of each type that match the currently selected primary item. If the design engine 305 in step 960 determines that there are no more primary items to examine, then the design engine jumps to step 970 to store the combination results. Method 900 then ends.

For illustrative purposes, an example story demonstrating the benefits and possible business processes employing the systems and methods described above is provided hereafter. Sarah and Rob have just moved to Northern California from Southern California on a job transfer. Although both are working, Sarah is pregnant and will probably stay home for a while after the baby is born. They just purchased a home and are looking to furnish it, since they brought only a few pieces with them from Southern California. Although they are not in a hurry to purchase everything at once, they are in a hurry to purchase furniture for their master bedroom and a comfortable family room sofa, chairs and coffee table.

Sarah notices an article in the home section of the San Jose Mercury News about a new furniture store which offers customers the opportunity to try different furnishing combinations online or in the store, all pre-designed by interior designers to match up to an individual's style preferences, color choices and budget. While Rob is out of town on business, Sarah has a free evening and heads over to the store. Although excited to see a large variety of furnishings that she would love to own, she is a bit overwhelmed. When the sales associate greets her, Sarah tells her that she is looking for a king bed, a couple night tables and family room furniture—but that she has no idea where to start.

The sales associate takes her to a comfortable stool by the kitchen bar and tells her to log on. The logon screen requests only her first and last name and an email address. Sarah is prompted for an optional password if she wants greater privacy (e.g., to keep others who know her name and email address from accessing her file). Regardless, Sarah's information is accessible to the store.

The system offers a design assistant link on the homepage. Sarah reads the brief description and clicks on the link. She is prompted to fill in five preferences: room type (e.g., dining room, child's bedroom, etc.), style preference (traditional, modern, etc.), color palette (warm colors, neutrals, etc.), budget (high, med, low) and existing pieces (items you already have, like your grandmother's dining table, indicating that you just need chairs and sideboard).

The system presents different furnishing combinations to Sarah. After playing with different furniture and fabric combinations, Sarah finds two combinations for each room that she likes. The sales associate shows her those available on the display floor, but has to show a similar bed to the one Sarah identified. Sarah asks the sales associate to bring out the color samples she tagged, along with the color print-out of the items and a description of each piece along with a price quote (proposal).

The furniture, fabric selections and price quotes are stored in Sarah's file so that she can show them to Rob when he gets back. After Sarah leaves the store with her packet of materials, the store has her email address and preference history. If Sarah does not come back in a few weeks, the store can email a list of new items made available that match her preferences, should they suit her needs better.

Three weeks later, both Sarah and Rob return to the store. Unfortunately, the original sales associate that assisted Sarah is off that day. However, another sales associate can easily pull up the file. The couple decides to buy a few items: a California King bed and mattress set, two night stands, a chest of drawers, a bench for their entry hall, a two-piece sectional sofa with extra down pillows and a large coffee table. Since Rob is not wild about the colors Sarah originally chose, they agree to different fabric choices. The purchased items and fabric/color choices are then entered into their file.

They make the purchases and are issued a line item receipt with estimated delivery dates. Once they leave the store, the orders are issued to the vendors. Each store SKU is tallied for access in reports, which indicate the more popular items, colors, vendors, etc. The sales associate tracks the progress of the order, stays in touch with the customers for any updates on delivery, delays, etc. and checks with the vendor to make sure the orders proceed as promised. The sales associate schedules the delivery and instructs the customer (via an email letter) to inspect the furniture upon delivery. The sales associate then sends a type written note via regular mail to thank the customer for the order and to make sure everything is in good working order.

To maintain an ongoing relationship, any new items that might coordinate well in the rooms with the known furnishings can be emailed to Sarah and Rob. Eighteen months later, Sarah and Rob return with their one-year-old child looking for baby furniture and a wall unit for the family room. A sales associate (whether the original or another) retrieves their file, and shows them product choices and fabric samples that match the furnishings purchased eighteen months earlier.

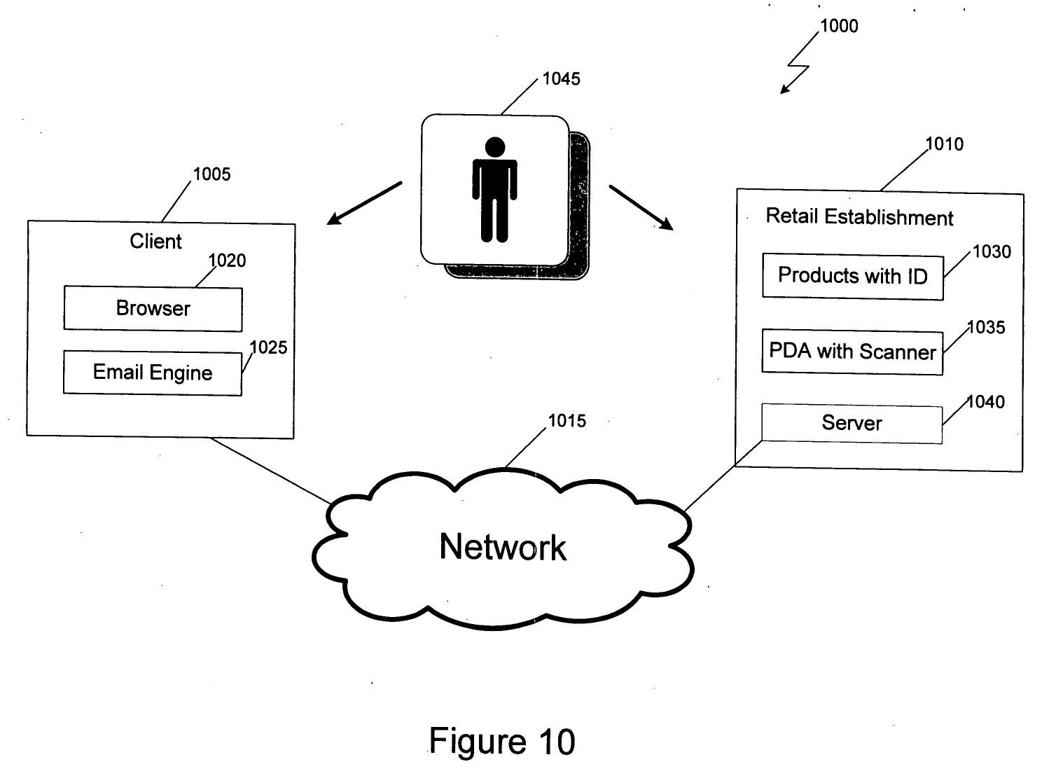

FIG. 10 is a block diagram of a network system 1000, in accordance with an embodiment of the present invention. Network system 1000 includes a client 1005 coupled via a computer network 1015 (such as the WAN commonly referred to as the Internet) to a retail establishment 1010. The client 1005 in this embodiment includes a browser 1020 (such as Netscape Navigator™ or Internet Explorer™) and an email engine 1025 (such as Yahoo! Mail™ or Microsoft Outlook™). The retail establishment 1010 in this embodiment includes a variety of products 1030, at least one PDA 1035 (preferably one per customer or customer group patronizing the retail establishment 1010) and a server 1040. Although not shown, in this embodiment, the PDA 1035 is preferably in wireless communication with the server 1040.

In one case, a customer 1045 may use the browser 1020 of the client 1005 to browse an online store (not shown) hosted by the server 1040 of the retail establishment 1010. Alternatively, the customer 1045 may go in-person to the retail establishment 1010 to browse the products 1030 available. In this embodiment, staff at the retail establishment 1010 presents a PDA 1035 to each arriving customer (or customer group) 1045. Of course, not all customers need or may get a PDA 1035. Customers 1045 may be required by the retail establishment 1010 to leave car keys, a license, credit card information or some other personal item as collateral for the PDA 1035 or may be asked to leave some form of identification as evidence of the borrowing.

Using the PDA 1035, the customers 1045 enter product identification information into the PDA 1035. One skilled in the art will recognize that many alternative techniques can be used to provide product identification information, such as manual entry, RFID, customer selection from a menu of products, etc. However, for convenience, the PDA 1035 of this embodiment includes a bar code scanner and each product 1030 includes a bar code. In this embodiment, the customers 1045 use the PDA 1035 to scan bar codes of products 1030 of interest to them.

Using the PDA 1035, the customer 1045 can collect information (such as product identification, product specifications, alternative size options, alternative design options, alternative fabric options, inventory information, e.g., whether the product or a related item is in stock, etc.) for the selected products 1030. In one embodiment, the PDA 1035 receives a request for information from a customer, and in response transmits an information request (or instruction) wirelessly to the server 1040. The server 1040 then responds to the request, e.g., by sending the requested information back to the PDA 1035. In an alternative embodiment, the product information may be stored on the PDA 1035, and no communication with the server 1040 may be necessary for gathering product information. In yet another embodiment, part of the information may be stored on the PDA 1035 and part of the information may be stored on the server 1040. For example, general product specifications (e.g., product dimensions) may be stored on the PDA 1035, and extended product information (e.g., alternative design options and/or alternative fabric options) may be stored on or obtained by the server 1040.

Using the PDA 1035, the customer 1040 may be provided the capability to email themselves the product identification and/or the collected information to their home (or other, e.g., their spouses) email addresses. In one embodiment, the customer 1045 requests that product information be emailed. In response, the PDA 1035 requests an email address and identification of the products desired. The PDA 1035 transmits the email address and product identification to the server 1040, which then sends the information to the identified email address. Other embodiments are also possible. For example, no email address may need to be entered at this time, as it may already be on file. No additional product identification need be entered, as the PDA 1035 may send the product identification of all products scanned to the customer's email address. The PDA 1035 may request that the customer 1045 indicate the details desired in the email (e.g., the image, product specifications, additional fabrics, additional colors, additional designs, and/or the like). Further, in yet another embodiment, the PDA 1035 may be wirelessly connected to an ISP (not shown) without an intermediate server 1040, and thus may be capable of sending the email without assistance of any server 1040.

The customer 1040 can request other associated services that may be available, like searching for coordinating products, searching for coupons, purchasing the products 1030, etc. In one embodiment, the PDA 1035 may include an application program interface (API) to the design assistant 125, which may determine coordinating products 1030 for the customer 1045 to consider. In another embodiment, the PDA 1035 may include the code for providing the associated service itself (e.g., the design assistant 125 itself).

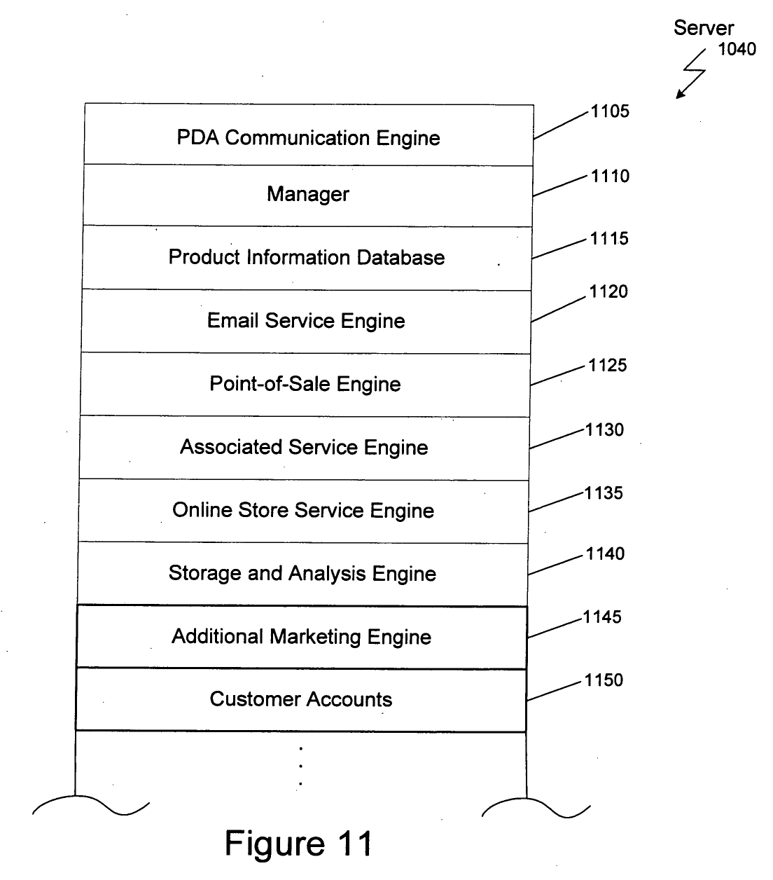

The retail establishment 1010 preferably gathers and stores the scanned and requested information for internal use, such as inventory management, developing directed marketing programs, setting prices, etc. These internal uses are described in greater detail with reference to FIG. 11.

Although in this embodiment the server 1040 is shown as located on the premises of the retail establishment 1010, one skilled in the art will recognize that the server 1040 can be located remotely. Similarly, although in this embodiment the PDA 1035 is illustrated and described as being the property of the retail establishment, one skilled in the art will recognize that the PDA 1035 may be the property of the customer 1045, e.g., its functions may be incorporated into a customer device 1045 such as a cell phone. The functionality of the PDA 1035 can be incorporated into any mobile device. In one embodiment, the software may be loaded onto a mobile device (e.g., a telephone) owned by the customer 1045 upon entering the retail establishment 1010.

FIG. 11 is a block diagram illustrating details of the server 1040, in accordance with an embodiment of the present invention. The server 1040 includes a PDA communication engine 1105, a manager 1110, product information 1115, an email service engine 1120, a point-of-sale engine 1125, an associated service engine 1130, an online store service engine 1135, a storage and analysis engine 1140, an additional-marketing engine 1145 and customer accounts 1150. As stated above, many of these elements may be located directly on the PDA 1035, overcoming the need for a server 1040 all together.

The PDA communication engine 1105 communicates with the PDA 1035, preferably using a wireless protocol, e.g., 802.11(g), BlueTooth, radio frequency, etc. Manager 1110 receives, stores and processes requests from the PDA 1035. Such requests may include requests for additional product information, requests for sending additional information to a chosen email account, requests to purchase a product 1030, requests for an associate service, etc. Upon receiving a request for additional product information, the manager 1110 accesses a product information database 1115. The product information database 1115 may include the specifications of products 1030, alternative fabric options, alternative style options, alternative colors, inventory information such as whether a product or a related item is in stock, etc., and may include for example furnishings database 130. The manager 1110 sends the requested information back to the PDA 1035 for presentation to the customer 1045.

Upon receiving a request to forward product information to an email account, the manager 1110 instructs the email service engine 1120 (which is coupled to the network 1015) to send an email containing the product information to an email address provided by the customer 1045. It will be appreciated that use of the PDA 1035 may be conditioned on the customer 1045 providing an email address upon set-up. The manager 1110 may request the customer 1045 to indicate the details desired in the email.

Upon receiving a request to purchase a product 1030, the manager 1110 may instruct the point-of-sale engine 1125 to begin and possibly complete the transaction. In one embodiment, the manager 1110 communicates the request to a sales associate (e.g., to a pager, to an electronic list at the point-of-sale terminal, etc.). The sales associate can obtain the requested product 1030 from the stock room so that the product is waiting at the terminal payment for the customer to pick it up. In another embodiment, the manager 1110 communicates the request to a customer service desk for ordering. In yet another embodiment, the manager 1110 communicates the request to the point-of-sale engine 1125, which completes the transaction via the PDA 1035 (e.g., as a credit card order). The product 1030 may then be shipped directly to the customer's home. One skilled in the art will note that other alternatives are also possible.

Upon receiving a request for an associated service, the manager 1110 communicates with the associated service engine 1130 to provide the associated service. For example, the associated service 1130 may provide automated interior design planning and furnishing selection as described above with reference to FIGS. 1-9B. In one embodiment, the PDA 1035 presents the option of finding pieces that coordinate with the selected piece. The associated service engine 1130 may include the design assistant 125 or an API to the design assistant 125. It will be appreciated that the user preference information and room requirements may be provided at this time or may have been provided by the customer 1045 at an earlier time. It will be appreciated that the term “associated service” is intended to include any service associated with this or other related products, inclusive of the email service provided by the email service engine 1120, the point-of-sale service provided by the point-of-sale engine 1125, and like services. The term “design service” is intended to include any design service, inclusive of the services provided by the design assistant 125.

The online service engine 1135 may provide online browsing capabilities to the customer 1045. Access to the functions offered by the associated service engines 1130 available may also be available via the online service engine 1135.

The storage and analysis engine 1140 gathers and stores scanned and requested information in customer accounts 1150 for future use. Such future use may include internal uses such as inventory management, marketing program development, in-store product sample selection, etc. The storage and analysis engine 1140 may enable a sales associate or an owner to browse the scanned items, purchased items, requested information, requests for associated services, etc. and may be capable of generating tables and graphs indicating general customer interest, popularity, color preferences, etc. The sales associate may use this information to develop mass marketing programs, inventory management decisions, etc. The storage and analysis engine 1140 may also be capable of collecting specific customer interest, color preferences, style preferences, home information, specific needs, etc. The sales associate may browse this information to develop targeted advertising programs. For example, by studying the particular customer's shopping behaviors (including scanned items, requested information, emails sent, purchased items, etc.), a sales associate may be able to better understand and target the client with advertisements. The sales associate may be in a better position to market sales on specific products, new products similar to ones previously scanned, new products that coordinate well with a product previously purchased, etc. It will be appreciated that the sales associate may use the design assistant 125 to determine the products coordinating with a customer's purchased product. Other uses include external uses, e.g., enabling the customer to review his or her selections, alternative designs, etc. via future in-store visits, via internet shopping, or via combinations of both. Many other uses of the gathered information are also possible.

The additional marketing engine 1145 may be configured to send advertisements automatically to customers 1045 (either to their email addresses or home addresses) based upon the scanning and requests made. Further, the additional marketing engine 1145 may be configured to send advertisements automatically to the PDA 1035 while the customer is still in the store, to the email engine 1025 of the client 1005, or to any other device or place associated with the customer 1045 at any other time. These advertisements may include advertisements for the products 1030 scanned, like products, coordinating products, other products selected by others who selected the same scanned products, etc.

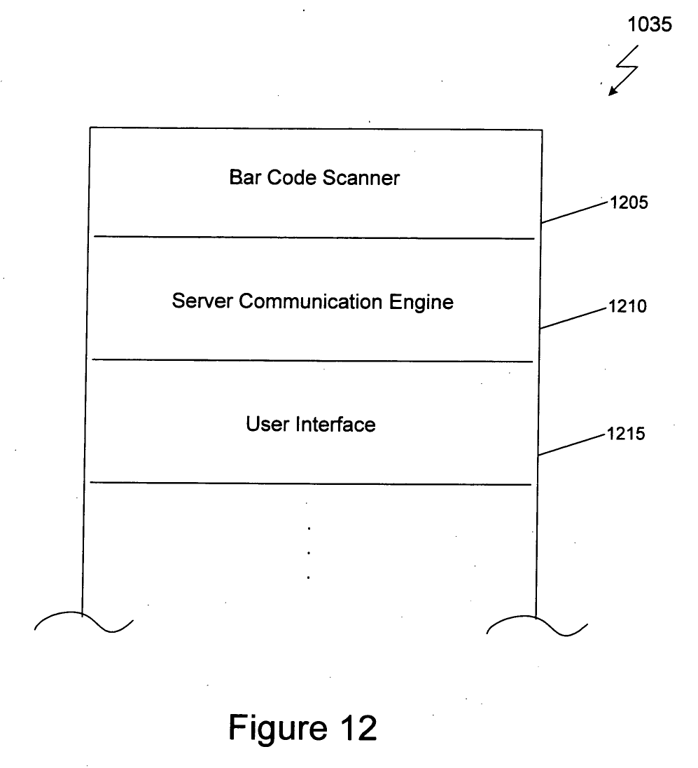

FIG. 12 is a block diagram illustrating details of the PDA 1035, in accordance with an embodiment of the present invention. The PDA 1035 includes a bar code scanner 1205 (which can be replaced with any other product identification mechanism, e.g., RFID, manual entry, etc.). The PDA 1035 also includes a server communication engine 1210 which communicates with the PDA communication engine 1105, preferably using a wireless protocol such as 802.11(g), Bluetooth, etc. The PDA 1035 also includes a user interface 1215, whether graphical or textual.

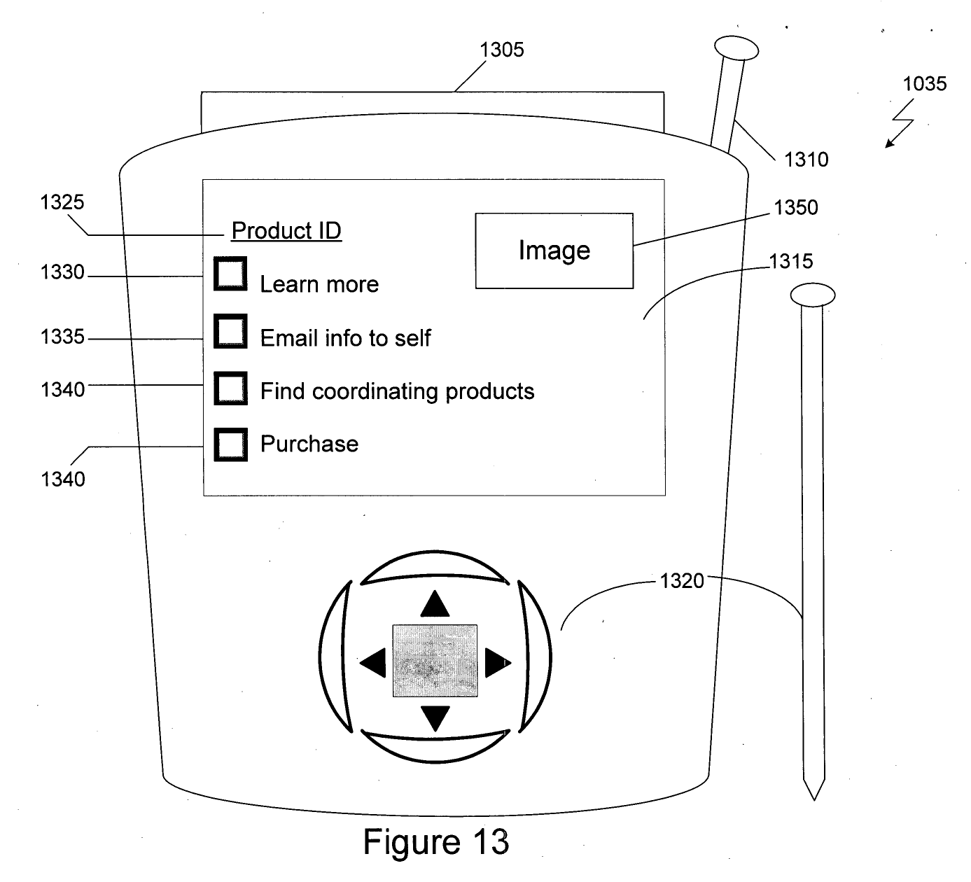

FIG. 13 illustrates an example of PDA 1035, in accordance with another embodiment of the present invention. The PDA 1035 includes a product identification mechanism 1305 (e.g., a bar code scanner, an RFID, etc.), an antenna 1310 for communicating wirelessly with the server 1040, a graphical user interface 1315 and input devices 1320 (e.g., directional buttons, a selection button, and a stylus). In this embodiment, the graphical user interface 1315 includes a product identifier 1325 next to an image 1350 of the product, an electronic button labeled “Learn More” for requesting product information such as the product specifications, an electronic button labeled “Email Info to Self” for requesting the system to email product information to a predetermined or entered email address, an electronic button labeled “Find Coordinating Products” for requesting the system to launch the design assistant 125 functions, and/or an electronic button labeled “Purchase” for requesting the system to initiate a transaction to purchase the selected product.

In one embodiment, the PDA 1035 may include a “save” button. Upon selection of the “save” button, the PDA 1035 may automatically initiate saving the information to the customer's account 1150, may automatically initiate an email to the customer's email address, may automatically initiate an email to a friend's account for viral marketing, and/or the like. In another embodiment, the email to the friend may occur only upon customer request. In yet another embodiment, the saves and the launching of emails may occur using a batch process, wherein all saves and/or emails occur at a single time, e.g., at the end of the day or upon request, at predetermined times, etc.

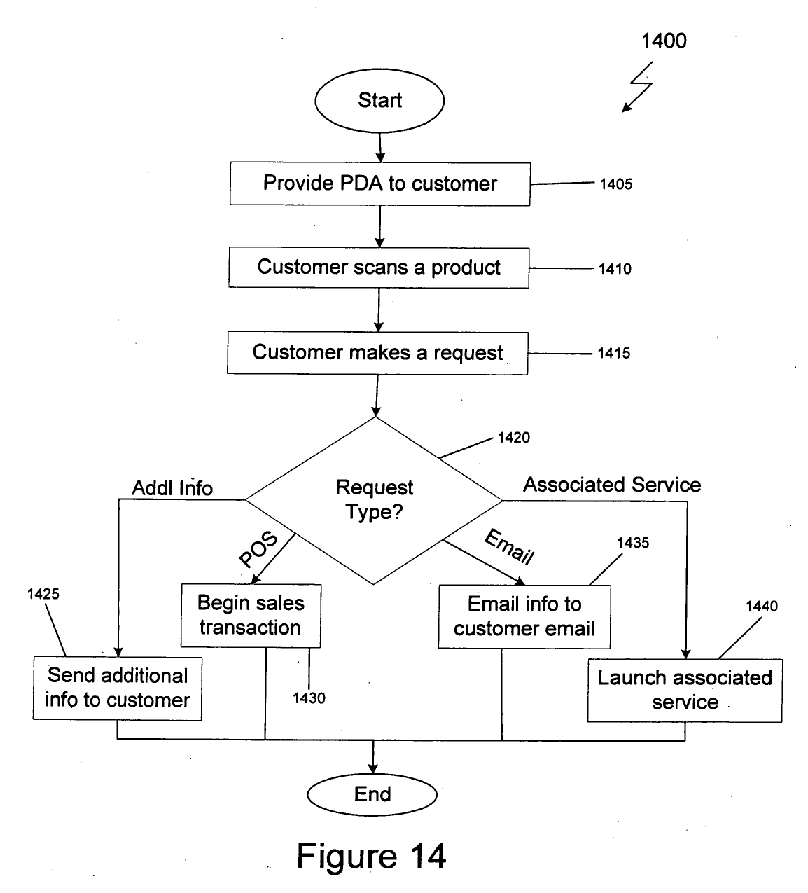

FIG. 14 is a flowchart illustrating a method 1400 of assisting a customer 1045 with customer service, in accordance with an embodiment of the present invention. Method 1400 begins in step 1405 with a sales associate providing a PDA 1035 to the customer 1045. The customer 1045 in step 1410 uses the PDA 1035 to identify a product (e.g., a sofa) 1030 of interest and in step 1415 makes a particular request. The PDA 1035 in step 1420 determines the request type and responds accordingly. If the PDA 1035 determines that the request is for additional information, then the method 1400 jumps to step 1425. In one embodiment, in step 1425, the PDA 1035 requests additional information from the server 1040, which transmits the information back to the PDA 1035 and thus to the customer 1045. Other techniques are also possible for sending the additional information to the customer 1045. If the PDA 1035 determines that the request is for a product sale, then the method 1400 jumps to step 1430. In one embodiment, in step 1430, the PDA 1035 sends the request to the server 1040, which initiates and possibly completes the sales transaction. As stated above, initiation of the transaction may include sending a request to a sales associate to obtain the item from the stock room. The transaction may include electronic payment. If the PDA 1035 determines that the request is for an email transaction, then the method 1400 jumps to step 1435. In one embodiment, in step 1435, the PDA 1035 sends the email request to the server 1040, which emails the requested information to the customer's email account. As stated above, the PDA alternatively may send the email itself. If the PDA 1035 determines that the request is for launching an associated service, then the method 1400 jumps to step 1440. In one embodiment, in step 1440, the PDA 1035 sends the request to the server 1040, which launches the associated service engine 1130 to respond to the customer's request. Alternatively, the PDA 1035 may launch the service itself. Method 1400 then ends.

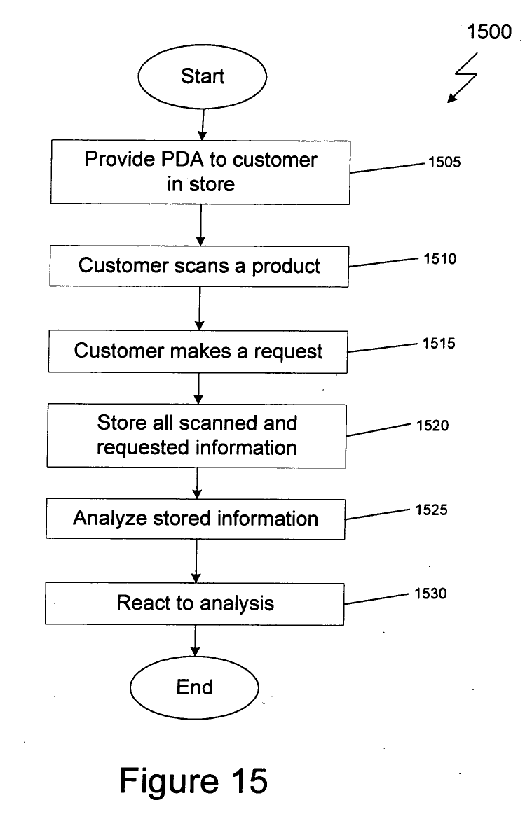

FIG. 15 is a flowchart illustrating a method 1500 of gathering and analyzing scanned and requested information for internal use, in accordance with an embodiment of the present invention. Method 1500 begins in step 1505 with the sales associate giving the PDA 1035 to the customer 1045 in the retail establishment 1010. The customer 1045 uses the PDA 1035 in step 1510 to scan an item and in step 1515 to make a request. The storage and analysis engine 1140 in step 1520 stores all scanned and requested information in a database, e.g., customer accounts 1150. Using the storage and analysis engine 1140, a sales associate in step 1525 may analyze the stored information and in step 1530 may react to the analyzed information by, for example, developing a mass marketing or directed advertising campaign.

For illustrative purposes, an example story demonstrating the benefits and possible business processes employing the mobile-device-based systems and methods described above is provided hereafter. A customer enters the store and is greeted by an in-store employee who informs them of the availability of a mobile device assistant. The customer is given a short explanation telling them what the mobile device can do and how it can help them with their shopping experience. The customer signs-in to get a private ID code and password, gives a home and/or email address, or just swipes a credit card on a magnetic reader attached to the device (but may still give their email address on sign-in or sign-out). The customer's information may be forwarded, preferably automatically and wirelessly, to the store's computer for storage, future marketing, follow-ups, confirmations, charges, etc.

The customer walks around the store with the mobile device. The customer finds a sofa and identifies items of interest with the mobile device, possibly using a bar code reader. On the mobile device screen, sofa information including size, price, and any special details appears. The customer clicks an onscreen button for other size option, an onscreen button for other fabric options, an onscreen button for coordinating products (e.g., furniture), and/or an onscreen button to save the information for future use by the customer at home or from the store, by a store employee, or the like. Any items scanned are saved to the customer's file, and may be emailed to the customer's email automatically or upon request. The process may repeat for any other items scanned.

The customer can input selected items to the design assistant by a synchronization mechanism to the store's computer, which has access to the design assistant. That way, the customer can use the design assistant to determine appropriateness for the intended room, floor plans or coordinating products/furnishings, etc. The saved combinations may be sent to the customer's email automatically or upon request.

When finished, the customer then returns the mobile device to the store employee. A security alarm may ring if the mobile device is taken from the store. Alternatively, if the customer leaves the store with the mobile device, a customer's credit card can be charged for its value. The system may track date/time and customer information, so that the store employees can track usage and/or possession.

The customer may purchase items at any time, using the mobile device or by conventional protocols (e.g., via sales staff at a cash register).

Since the customer has indicated items of interest and provided the store with valuable information (e.g., preferences, home needs, marital information, etc.), sales staff can review the information to develop general and/or targeted advertising schemes, review inventory, etc. Further, the customer may be able to review the items identified upon return to the store or via internet connection. One spouse may more easily show items of interest to the other spouse.

Claims to consider for future applications:

Email:

1. A system, comprising:

products for sale in a retail establishment, each product having a product identifier; and

a mobile device controlled by a customer of the retail establishment, the mobile device for receiving one of the product identifiers and for initiating the sending of an email containing product information corresponding to the received product identifier.

2. The system of claim 1, wherein the product identifier is a bar code and the mobile. device includes a bar code scanner for receiving the product identifier.

3. The system of claim 1, wherein the mobile device is a PDA provided to the customer by the retail establishment.

4. The system of claim 1, further comprising a server including an email service engine for sending the email, and wherein the mobile device communicates the product identifier to the server.

5. The system of claim 1, wherein the mobile device includes an email service engine for sending the email.

6. A method, comprising:

receiving a product identifier of a product for sale in a retail establishment by a mobile device, the mobile device being controlled by a customer of the retail establishment; and

initiating the sending of an email containing product information corresponding to the received product identifier.

7. The method of claim 6, wherein the receiving includes scanning a bar code.

8. The method of claim 6, wherein the mobile device is a PDA provided to the customer by the retail establishment.

9. The method of claim 6, further comprising using an email server to send the email, and wherein the initiating includes communicating the product identifier to the email server.

10. The system of claim 6, further comprising using the mobile device to send the email.

Coordinating Products:

21. A system, comprising:

products for sale in a retail establishment, each product having a product identifier;

a mobile device being controlled by a customer of the retail establishment, the mobile device for receiving a product identifier; and

a design assistant for suggesting other products that coordinate with the product corresponding to the received product identifier.

22. The system of claim 21, wherein the product identifier is a bar code and the mobile device includes a bar code scanner for receiving the product identifier.

23. The system of claim 21, wherein the mobile device is a PDA provided to the customer by the retail establishment.

24. The system of claim 21, wherein the design assistant is located on a server.

25. The system of claim 21, wherein the design assistant is located on the mobile device.

26. A method, comprising:

receiving a product identifier of a product for sale in a retail establishment by a mobile device, the mobile device being controlled by a customer of the retail establishment; and

suggesting other products that coordinate with the product corresponding to the product identifier.

27. The method of claim 26, wherein the receiving includes scanning a bar code.

28. The method of claim 26, wherein the mobile device is a PDA provided to the customer by the retail establishment.

Inventory Management:

29. A system, comprising:

products for sale in a retail establishment, each product having a product identifier;

a mobile device being controlled by a customer of the retail establishment, the mobile device for enabling the customer to selectively enter one of the product identifiers; and

a database for storing product information of products corresponding to entered product identifiers.

30. The system of claim 29, wherein the product identifier is a bar code and the mobile device includes a bar code scanner for receiving the product identifier.

31. The system of claim 29, wherein the mobile device is a PDA provided to the customer by the retail establishment.

32. The system of claim 29, wherein the database is located on a server.

33. The system of claim 29, wherein the database is located on the mobile device.

34. A method, comprising:

enabling a customer to selectively enter a product identifier of a product for sale in a retail establishment into a mobile device, the mobile device being controlled by the customer; and

storing product information of the product corresponding to the entered product identifier.

35. The method of claim 34, wherein the product identifier is a bar code.

36. The method of claim 34, wherein the mobile device is a PDA provided to the customer by the retail establishment.

37. The method of claim 34, wherein the storing includes storing the product information in a database located on a server.

38. The method of claim 34, wherein the storing includes storing the product information in a database located on the mobile device.

Future Marketing:

39. A system, comprising:

products for sale in a retail establishment, each product having a product identifier;

a mobile device controlled by a customer of the retail establishment, the mobile device for enabling the customer to selectively enter one of the product identifiers; and

a database for storing customer information and customer activity information.

40. The system of claim 39, wherein the product identifier is a bar code and the mobile device includes a bar code scanner for capturing the product identifier.

41. The system of claim 39, wherein the mobile device is a PDA provided to the customer by the retail establishment.

42. The system of claim 39, wherein the database is located on a server.

43. The system of claim 39, wherein the database is located on the mobile device.

44. A method, comprising:

enabling a customer to selectively enter a product identifier of a product for sale in a retail establishment in a mobile device, the mobile device being controlled by the customer of the retail establishment; and

storing customer information and customer activity information.

45. The method of claim 44, wherein the product identifier is a bar code.

46. The method of claim 44, wherein the mobile device is a PDA provided to the customer by the retail establishment.

47. The method of claim 44, wherein the storing includes storing the customer information and customer activity information in a database located on a server.

48. The method of claim 44, wherein the storing includes storing the customer information and customer activity information in a database located on the mobile device.

The foregoing description of the preferred embodiments of the present invention is by way of example only, and other variations and modifications of the above-described embodiments and methods are possible in light of the foregoing teaching. Although the network sites are being described as separate and distinct sites, one skilled in the art will recognize that these sites may be a part of an integral site, may each include portions of multiple sites, or may include combinations of single and multiple sites. The various embodiments set forth herein may be implemented utilizing hardware, software, or any desired combination thereof. For that matter, any type of logic may be utilized which is capable of implementing the various functions set forth herein. Components may be implemented using a programmed general-purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

What is claimed is:

1. A system, comprising:
products for sale in a retail establishment, each product having a product identifier; and
a mobile device controlled by a customer of the retail establishment, the mobile device for receiving one of the product identifiers and for presenting product information corresponding to the received product identifier.

2. The system of claim 1, wherein the product identifier is a bar code and the mobile device includes a bar code scanner for receiving the product identifier.

3. The system of claim 1, wherein the mobile device is a PDA provided to the customer from the retail establishment.

4. The system of claim 1, further comprising a server capable of accessing a product information database storing the product information corresponding to the received product identifier and including a mobile device communication engine for communicating the product information to the mobile device.

5. The system of claim 1, wherein the mobile device includes a database storing the product information corresponding to the received product identifier.

6. A method, comprising:
receiving a product identifier of a product for sale in a retail establishment by a mobile device, the mobile device being controlled by a customer of the retail establishment;
obtaining product information corresponding to the received product identifier; and
presenting the product information on the mobile device.

7. The method of claim 6, wherein the receiving includes scanning a bar code.

8. The method of claim 6, wherein the mobile device is a PDA provided to the customer from the retail establishment.

9. The method of claim 6, wherein the obtaining includes receiving the product information from a server.

10. The method of claim 6, wherein the receiving includes accessing a product information database on the mobile device.

11. A method, comprising:
receiving a customer in a retail establishment;
providing a mobile device to the customer;
enabling the customer to use the mobile device to selectively enter product identifiers of products in the retail establishment; and
enabling the customer to request an associated service in the retail establishment, the associated service using the product identifier.

12. The method of claim 11, wherein the associated service is an email service.

13. The method of claim 11, wherein the associated service is a point-of-sale service.

14. The method of claim 11, wherein the associated service is a design assistant service.

15. The method of claim 11, wherein the associated service is a product information service.

16. The method of claim 11, wherein the associated service is storage service.

17. A method, comprising:
receiving a product identifier of a product for sale in a retail establishment by a mobile device, the mobile device being controlled by a customer of the retail establishment;
receiving a request to purchase the product corresponding to the product identifier from the customer;
informing a sales associate of the request.

18. The method of claim 17, further comprising the step of initiating the purchase of the product.

19. The method of claim 17, further comprising the step of initiating retrieval of the product so that the product is waiting at a more convenient location in the retail establishment.
